(19) United States
(12) Patent Application Publication
(10) Pub. No.: US 2022/0161830 A1
(43) Pub. Date: May 26, 2022

(54) Dynamic Scene Representation

(71) Applicant: Lyft, Inc., San Francisco, CA (US)

(72) Inventors: Joan Devassy, San Mateo, CA (US); Mousom Dhar Gupta, London (GB); Sakshi Madan, Sunnyvale, CA (US); Emil Constantin Praun, Union City, CA (US)

(21) Appl. No.: 17/101,831

(22) Filed: Nov. 23, 2020

(51) Int. Cl. B60W 60/00; B60W 50/00; B60W 30/095

(52) U.S. Cl. CPC B60W 60/00274; B60W 50/0097; B60W 2556/10; B60W 2554/20; B60W 2554/806; B60W 30/0956

(57) ABSTRACT

Examples disclosed herein involve a computing system configured to (i) receive sensor data associated with a vehicle's period of operation in an environment including (a) trajectory data associated with the vehicle and (b) at least one of trajectory data associated with one or more agents in the environment or data associated with one or more static objects in the environment, (ii) determine that at least one of (a) the one or more agents or (b) the one or more static objects is relevant to the vehicle, (iii) identify one or more times when there is a change to the one or more agents or the one or more static objects relevant to the vehicle, (iv) designate each identified time as a boundary point that separates the period of operation into one or more scenes, and (v) generate a representation of the one or more scenes based on the designated boundary points.

### BACKGROUND

Vehicles are increasingly being equipped with sensors that capture sensor data while such vehicles are operating in the real world, and this captured sensor data may then be used for many different purposes, examples of which may include building an understanding of how vehicles and/or other types of agents (e.g., pedestrians, bicyclists, etc.) tend to behave within the real world and/or creating maps that are representative of the real world. The sensor data that is captured by these sensor-equipped vehicles may take any of various forms, examples of which include Global Positioning System (GPS) data, Inertial Measurement Unit (IMU) data, camera image data, Light Detection and Ranging (LiDAR) data, Radio Detection And Ranging (RADAR) data, and/or Sound Navigation and Ranging (SONAR) data, among various other possibilities.

### SUMMARY

In one aspect, the disclosed technology may take the form of a method that involves (i) receiving sensor data associated with a period of operation in an environment by at least one sensor of a vehicle, wherein the sensor data includes (a) trajectory data associated with the vehicle during the period of operation, and (b) at least one of trajectory data associated with one or more agents in the environment during the period of operation or data associated with one or more static objects in the environment during the period of operation, (ii) determining, at each of a series of times during the period of operation, that at least one of (a) the one or more agents or (b) the one or more static objects is relevant to the vehicle, wherein determining that at least one of (a) the one or more agents or (b) the one or more static objects is relevant to the vehicle is based on a likelihood that at least one of (a) the one or more agents or (b) the one or more static objects is predicted to affect a planned future trajectory of the vehicle, (iii) identifying, from the series of times, one or more times during the period of operation when there is a change to at least one of (a) the one or more agents or (b) the one or more static objects determined to be relevant to the vehicle, (iv) designating each of the one or more identified times as a boundary point that separates the period of operation into one or more scenes, and (v) generating a representation of the one or more scenes based on the designated boundary points, wherein each of the one or more scenes includes (a) a portion of the trajectory data associated with the vehicle, and (b) at least one of a portion of the trajectory data associated with the one or more agents or a portion of the data associated with the one or more static objects.

In some example embodiments, generating a representation of the one or more scenes may involve generating a respective representation of each of the one or more scenes that includes (i) the trajectory data for the vehicle during the scene and (ii) one or both of (a) trajectory data for at least one agent that is determined to be relevant to the planned future trajectory of the vehicle during the scene, or (b) data associated with at least one static object that is determined to be relevant to the planned future trajectory of the vehicle during the scene.

Further, in example embodiments, one or both of (i) the trajectory data for the vehicle during the scene or (ii) the trajectory data for the at least one agent that is determined to be relevant to the planned future trajectory of the vehicle during the scene may include confidence information indicating an estimated accuracy of the trajectory data.

Further yet, in example embodiments, identifying, from the series of times, one or more times during the period of operation when there is a change to at least one of (i) the one or more agents or (ii) the one or more static objects determined to be relevant to the vehicle may include determining that at least one of the one or more agents that was determined to be relevant to the vehicle is no longer relevant to the vehicle.

Still further, in some example embodiments, the method may involve, based on the received sensor data, deriving past trajectory data for (i) the vehicle and (ii) the one or more agents in the environment during the period of operation and, based on the received sensor data, generating future trajectory data for (i) the vehicle and (ii) the one or more agents in the environment during the period of operation.

Still further, in some example embodiments, wherein determining that at least one of (i) the one or more agents or (ii) the one or more static objects is relevant to the vehicle comprises predicting at least one of: (a) a likelihood that the planned future trajectory of the vehicle will intersect a predicted trajectory for the one or more agents, or (b) a likelihood that at least one of (i) the one or more agents or (ii) the one or more static objects will be located within a predetermined zone of proximity to the vehicle

Still further, in some example embodiments, the method may involve based on a selected scene included in the one or more scenes, predicting one or more alternative versions of the selected scene. In this regard, predicting one or more alternative versions of the selected scene may include generating, for the selected scene, one or more alternative versions of one or both of (i) the trajectory data for the vehicle during the scene or (ii) the trajectory data for at least one agent in the environment during the scene.

Still further, in some example embodiments, the method may involve, based on (i) a first scene included in the one or more scenes and (ii) a second scene included in the one or more scenes, generating a representation of a new scene comprising at least one of (i) trajectory data for the vehicle during the first scene or (ii) trajectory data for at least one agent in the environment during the first scene and at least one of (i) trajectory data for the vehicle during the second scene or (ii) trajectory data for at least one agent in the environment during the second scene.

Still further, in some example embodiments, determining that at least one of (i) the one or more agents or (ii) the one or more static objects is relevant to the vehicle may include determining that a probability that at least one of (i) the one or more agents or (ii) the one or more static objects will affect the planned future trajectory of the vehicle during a future time horizon exceeds a predetermined threshold probability.

In another aspect, the disclosed technology may take the form of a computing system comprising at least one processor, a non-transitory computer-readable medium, and program instructions stored on the non-transitory computer-readable medium that are executable by the at least one processor such that the computing system is configured to carry out the functions of the aforementioned method.

In yet another aspect, the disclosed technology may take the form of a non-transitory computer-readable medium comprising program instructions stored thereon that are executable to cause a computing system to carry out the functions of the aforementioned method.

It should be appreciated that many other features, applications, embodiments, and variations of the disclosed technology will be apparent from the accompanying drawings and from the following detailed description. Additional and alternative implementations of the structures, systems, non-transitory computer readable media, and methods described herein can be employed without departing from the principles of the disclosed technology.

### BRIEF DESCRIPTION OF THE DRAWINGS

FIG. 1A is a diagram that illustrates an example of a pairwise interaction between a vehicle and a pedestrian.

FIG. 1B is a diagram that illustrates another example of a pairwise interaction between a vehicle and a pedestrian.

FIG. 2A is a diagram that illustrates a vehicle operating in the real world and a simplified graph of a dynamic scene representation for the vehicle.

FIG. 2B is a diagram that illustrates the vehicle of FIG. 2A operating in the real world and the simplified graph of the dynamic scene representation for the vehicle.

FIG. 2C is a diagram that illustrates the vehicle of FIGS. 2A-2B operating in the real world and the simplified graph of the dynamic scene representation for the vehicle.

FIG. 2D is a diagram that illustrates the vehicle of FIGS. 2A-2C operating in the real world and the simplified graph of the dynamic scene representation for the vehicle.

FIG. 3 is a simplified block diagram of a remote computing platform and an example data flow.

FIG. 4A is a diagram that illustrates a vehicle operating in the real world and a simplified graph of a dynamic scene representation for the vehicle that is used as an input to a scene prediction model.

FIG. 4B is a diagram that illustrates a synthetic scene generated by the scene prediction model of FIG. 4A.

FIG. 4C is a diagram that illustrates another synthetic scene generated by the scene prediction model of FIG. 4A.

FIG. 4D is a diagram that illustrates another synthetic scene generated by the scene prediction model of FIG. 4A.

FIG. 4E is a diagram that illustrates a vehicle operating in the real world and a simplified graph of a dynamic scene representation for the vehicle.

FIG. 4F is a diagram that illustrates another vehicle operating in the real world and a simplified graph of a dynamic scene representation for the vehicle.

FIG. 4G is a diagram that illustrates a synthetic scene generated by a scene sampling model using the dynamic scene representations of FIG. 4E and FIG. 4F as inputs.

FIG. 4H is a simplified block diagram that illustrates an example embodiment of generating a synthetic scene.

FIG. 5 is a simplified block diagram that illustrates certain systems that may be included in an example vehicle.

FIG. 6 a simplified block diagram that illustrates one example of a transportation-matching platform.

FIG. 7 is a simplified block diagram that illustrates some structural components that may be included in an example computing platform.

### DETAILED DESCRIPTION

As noted above, vehicles are increasingly being equipped with sensors that capture sensor data while such vehicles are operating in the real world, such as Global Positioning System (GPS) data, Inertial Measurement Unit (IMU) data, camera image data, Light Detection and Ranging (LiDAR) data, Radio Detection And Ranging (RADAR) data, and/or Sound Navigation and Ranging (SONAR) data, among various other possibilities, and this captured sensor data may then be used for many different purposes. For instance, sensor data that is captured by sensor-equipped vehicles may be used to build an understanding of how vehicles and/or other types of agents (e.g., pedestrians, bicyclists, etc.) tend to behave within the real world and/or create maps that are representative of the real world.

One possible use for such sensor data is to analyze the data to develop an understanding of how human drivers in the real world react or otherwise make decisions when faced with different scenarios during operation of a vehicle. Generally speaking, a given set of circumstances that a vehicle may encounter (e.g., interactions with other agents) during a given period of operation may be referred to as a “scene,” and may represent a timeframe during which a human driver made one or more decisions related to driving the vehicle in a safe and efficient way. Accordingly, human driving behaviors across scenes having similar characteristics (i.e., a same “type” of scene) may be identified from within the captured sensor data and then analyzed to develop an understanding of how human drivers make decisions when confronted with that type of scene. In this regard, scenes may be analyzed and used for various purposes, including to train scenario detection models, evaluate technology employed by on-vehicle computing systems, generate aspects of maps, or to improve the operation of a transportation matching platform, among other possibilities.

However, identifying scenes from captured sensor data to undertake this type of analysis has some limitations. For example, although some captured sensor data sets available for analysis may be relatively large, including data captured by numerous different sensors and vehicles at various different locations, the captured sensor data may nevertheless fail to represent the full universe of possible interactions that a vehicle may encounter. Indeed, the universe of possible variations that might affect the decision making of a human driver (and thus the universe of different types of scenes) is so large that it is not practically possible to capture every possible variation that might affect the decision making of a human driver with sensor data alone. Likewise, having engineers try to manually enumerate every possible type of scene and then hand-coding rules for distinguishing between those scenes would yield similarly incomplete results. Thus, when using sensor data alone to enumerate the universe of possible variations that might affect the decision making of a human driver, only a certain subset of variations can be incorporated in the types of analyses discussed above. As a result, it can be difficult to properly evaluate how human drivers behave in those specific scenarios, making it equally difficult to train models for use by an on-board computing system that are specifically tuned for those types of scenarios, or to test how existing models perform in those types of scenarios. This, in turn, could potentially lead to undesirable driving behavior by vehicles that are faced with those scenario types.

Similarly, certain types of less common interactions may be under-represented within the captured sensor data, such as scenes in which a human-driven vehicle encounters an emergency vehicle. Accordingly, the resulting analysis of human driving behavior in these types of scenes may be less robust, leading to challenges similar to those noted above.

Another challenge associated with using scenes identified from captured sensor data to understand human driving behavior is that it can be difficult to identify what types of interactions (e.g., with agents, with non-agents, and/or combinations thereof) are important to a decision-maker in order to define a relevant scene in the first instance. Indeed, current methods for surfacing scenes from a given set of sensor data generally involve defining scenes encountered by a vehicle in terms of one or more predetermined, pairwise interactions between the vehicle and a single other agent of interest. For example, an analysis of how humans drive when faced with a pedestrian crossing a crosswalk may involve querying a repository of previously-captured sensor data (and/or associated data derived from the sensor data such as object classifications) to identify times during which the vehicle encountered a pedestrian in a crosswalk. The returned periods of sensor data and/or other data that are associated with the interaction (e.g., sensor data frames or sequences of frames) are then encoded as separate pairwise interactions that each represent the scene of interest, and can then be used for one or more of the purposes above.

However, this type of search may not consider what other agents, if any, may have affected the decision maker's driving behavior in each pairwise interaction that was identified. Further, this type of analysis also typically does not consider what interactions or potential interactions with non-agent objects may have affected the driver's decision making. Indeed, some of the returned pairwise interactions may have involved other, dissimilar interactions with agents and/or non-agents that contributed to a given driving behavior.

Similar to identifying scenes from sensor data in a pairwise fashion, which is generally conducted off-vehicle, most on-vehicle autonomy systems in operation today only consider interactions in the world on an individual, object-by-object basis and do not look at connections and/or interactions between surrounding objects. For example, if there are two agents in the surrounding environment, current on-vehicle autonomy systems will consider interaction of the vehicle with the first agent and interaction of the vehicle with the second agent, but generally will not consider interactions between the first and second agents. Similarly, non-agent objects are typically only considered individually as well.

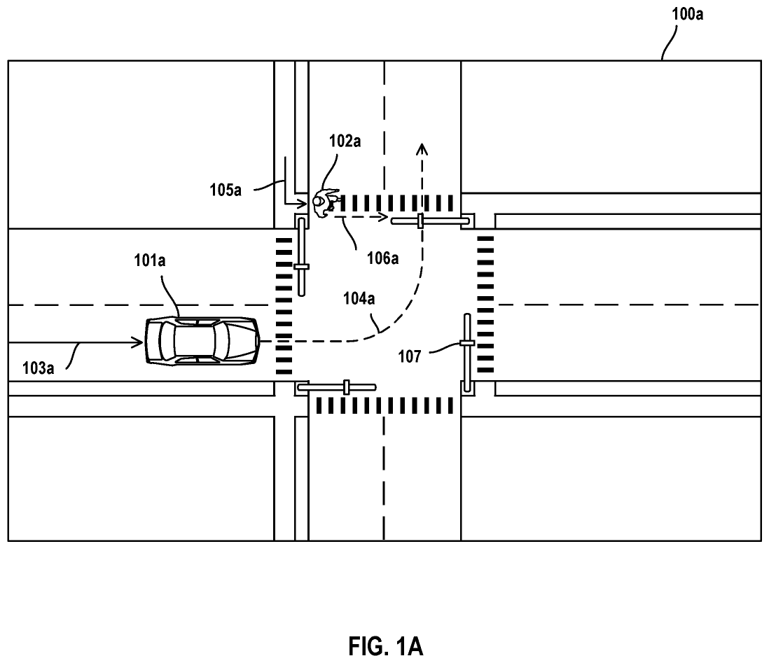

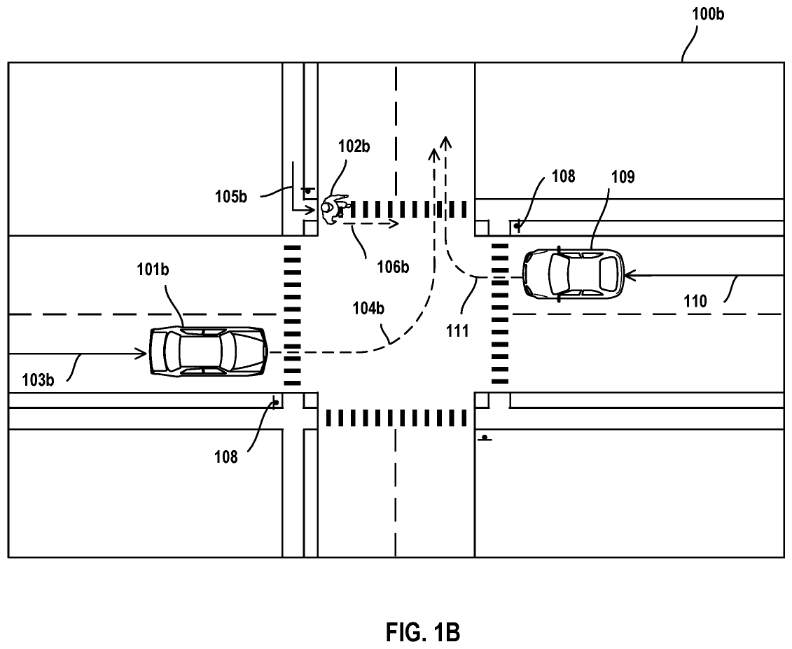

One example of the shortcomings of some existing approaches is shown in FIGS. 1A-1B, which illustrates two possible scenes that may be identified using a query of the type discussed above. In particular, the query of a repository of previously-captured sensor data may request scenes involving a vehicle and a pedestrian that was located in a crosswalk. Accordingly, FIG. 1A shows a first scene 100a that may be identified by such query, involving the pairwise interaction of a vehicle 101a and a pedestrian 102a at a four-way road intersection. As part of the scene 100a, the vehicle 101a includes a past trajectory 103a indicating the vehicle's time sequence of locations during a preceding window of time (e.g., five seconds), as well as a planned future trajectory 104a that indicates a time sequence of locations where the decision maker of vehicle 101a is expected to be for an upcoming window of time (e.g., five seconds).

Likewise, the scene 100a includes a past trajectory 105a for the pedestrian 102a, as well as a predicted future trajectory 106a that may be based on the past trajectory 105a as well as additional information that may be derived from the sensor data such as the pedestrian's orientation, velocity, acceleration, and the like. This information regarding the respective trajectories of the vehicle 101a and the pedestrian 102a may be returned by the query.

In addition, FIG. 1A illustrates that the four-way intersection in scene 100a is controlled by several traffic signals, of which traffic signal 107 is shown as one example, and that no other agents are present in the scene 100a. However, these additional details may not be returned as part of the query because they are incidental to the search criteria used to surface the scene 100a, even though they may have some impact on the decision making of a human driver of vehicle 101a and the pedestrian 102a.

Turning now to FIG. 1B, another scene 100b is illustrated that may be identified from the same query for scenes involving a vehicle and a pedestrian located in a crosswalk. Similar to the scene 100a shown in FIG. 1A, the scene 100b shows a four-way intersection wherein a vehicle 101b includes a past trajectory 103b and a planned future trajectory 104b, and a pedestrian 102b includes a past trajectory 105b and a predicted future trajectory 106b. As shown, the respective past and future trajectories of the vehicle 101b and the pedestrian 102b are approximately the same as those shown in scene 100a, and this data regarding the pairwise interaction of the vehicle 101b and the pedestrian 102b may be returned by the query. However, as may be apparent from a review of the two scenes as a whole, the resulting driving behavior of vehicle 101b may differ from that of vehicle 101a due to relevant differences between the scenes. In particular, scene 100b differs from scene 100a in ways that are relevant to a decision maker of vehicle 101b, as well as to the other agents within the scene.

For instance, in the scene 100b, the intersection is a four-way stop controlled by traffic signs (of which traffic sign 108 is shown as one example) rather than the traffic signals shown in scene 100a. Further, an additional agent—vehicle 109—is present in scene 100b. Vehicle 109 includes a past trajectory 110 as well as a predicted future trajectory 111, which indicates a potential future interaction with one or both of the vehicle 101b and the pedestrian 102b. Accordingly, the behavior of the vehicle 101b with respect to the pedestrian 102b may be influenced by the vehicle 109.

However, as noted above with respect to FIG. 1A, the differences between scene 100a and 100b involving non-agent objects (e.g., the traffic sign 108) and other agents (e.g., the vehicle 109) are incidental to the query criteria, and therefore the data regarding these differences may not be returned by the query. Nonetheless, the single pairwise interaction between a vehicle and a pedestrian in both scene 100a and 100b may satisfy the query. As a result, the query, and by extension, the downstream processes that utilize the results of the query, may treat scenes 100a and 100b to be two instances of the same type of scene, when in fact there were relevant differences between the scenes that affected the decision maker's behavior for specific interaction in question. This, in turn, may lead to issues similar to those noted above. For example, if both scene 100a and 100b are used to train a model that is specifically tuned for this type of scenario, or to test how existing models perform in those types of scenarios, the accuracy of the model or the performance evaluation is likely to be degraded. This, in turn, may lead to undesirable driving behavior by vehicles that are faced with those scenario types.

One possible solution to the issue of overly-generalized scene definitions noted above may involving performing a complex query that searches for occurrences of multiple different pairwise interactions taking place during a given time period and then defining the scene in terms of all the pairwise interactions that are returned by that complex query (e.g., first query for times when there is a pedestrian only, second query for times when there is a pedestrian and a stop sign but no other agents, third query for times when there is a pedestrian and a stop sign and additional vehicle agents, etc.). However, there may be various shortcomings associated with such an approach. As an initial matter, this might make searching much more difficult by increasing the computational resources and time necessary to distinguish between different scenes. Moreover, the results that would be returned by this type of query do not take into account the interrelationships between the agents and/or non-agents perceived by the vehicle and how those interrelationships impact decision making. Accordingly, this approach may not sufficiently tie the definition of a scene to the factors that affect driver decision making.

In view of these and other shortcomings with existing approaches for defining and identifying scenes that a vehicle may encounter, disclosed herein is a new data-driven approach for defining and then generating representations of “dynamic scenes” from a vehicle's period of operation, where each dynamic scene comprises a discrete “decision unit” for the vehicle. In this regard, a decision unit may be a unit of time during which there is no significant change in the inputs to driver's decision making related to the operation of the vehicle (e.g., a unit of time during which the aspects of the vehicle's surrounding environment that are relevant to the driver's decision making do not meaningfully change).

At a high level, the techniques discussed herein involve defining these dynamic scenes based on several different categories of information, including: (1) vehicle information that includes the past, current, and/or predicted future motion state of the vehicle, (2) agent information that includes the past, current, and/or predicted future motion state of agents in the vehicle's surrounding environment, and (3) non-agent information for the vehicle's surrounding environment (e.g., information regarding traffic signs, traffic maps, traffic cones, road lanes, road rules, etc.). This information may originate from any of various different types of sources (e.g., LiDAR-based sensor systems, camera-based sensor systems, telematics-only sensor systems, synthetic data sources, drone-based sensor systems, etc.), and such information may be represented in terms of a source-agnostic coordinate frame, as discussed in further detail below.

Using these different categories of information, an interaction prediction model may be used to determine, at each of various times during a vehicle's period of operation, the likelihood that an agent or non-agent will have an impact on the vehicle's decision making during a future-looking time horizon (e.g., ten seconds), sometimes referred to herein as a “decision horizon.” This likelihood may then be compared to a relevance threshold to determine whether the agent or non-agent is considered to be relevant to the vehicle's decision making at that point in time. As one possibility, the relevance threshold may be 5%, such that any agent or non-agent that is determined to be less than 5% likely to have an impact on the vehicle's decision making during the current decision horizon is considered to be not relevant. Whereas any agent or non-agent that is determined to be more than 5% likely to have an impact on the vehicle's decision making during the current decision horizon may be considered to be relevant. In some implementations, this likelihood of interaction may be based in part on a confidence level associated with the sensor data for a given agent or non-agent, as discussed in more detail below.

At each point in time that the interaction prediction model determines that there are changes to the surrounding agents and/or non-agents that are relevant to the vehicle (e.g., when a formerly relevant agent is no longer relevant, or when a new agent becomes relevant), the interaction prediction model may define a boundary point between dynamic scenes. In this regard, each new boundary point designates the end of the previous dynamic scene and the beginning of a new, different dynamic scene. Thus, a dynamic scene is defined as the interval of time between two such consecutive boundary points, and may be represented in terms of the combination of all agents and non-agents that were determined to be relevant to the vehicle's decision making during that interval of time.

In particular, a single, unified representation of each dynamic scene may be created that includes (1) vehicle information corresponding to the scene, (2) agent information corresponding to the scene for each agent that was considered to be relevant during the scene's time interval, and (3) non-agent information corresponding to the scene for each non-agent that was considered to be relevant during the scene's time interval. Thus, each dynamic scene represents a unified decision unit for the vehicle.

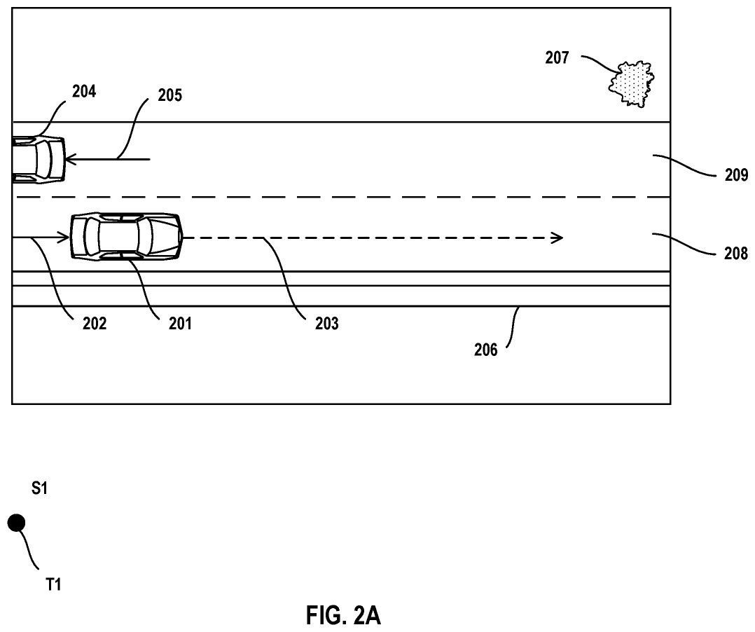

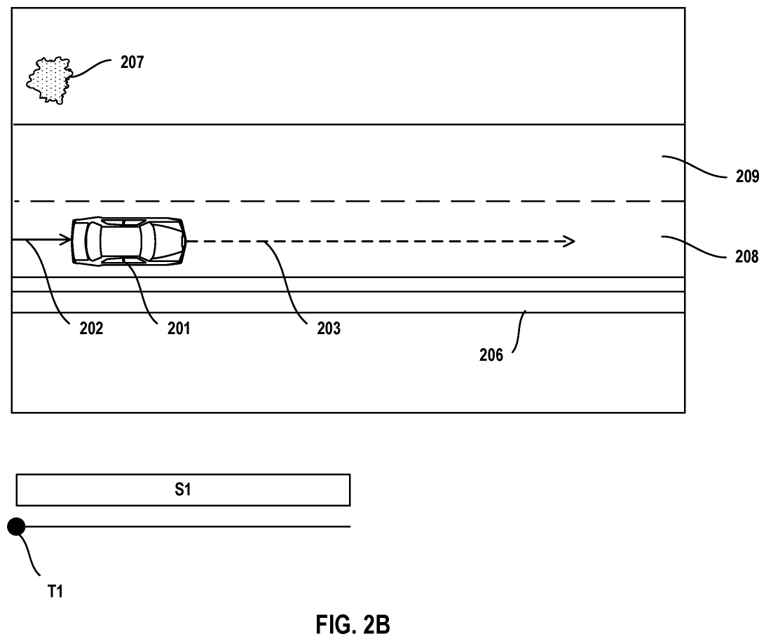

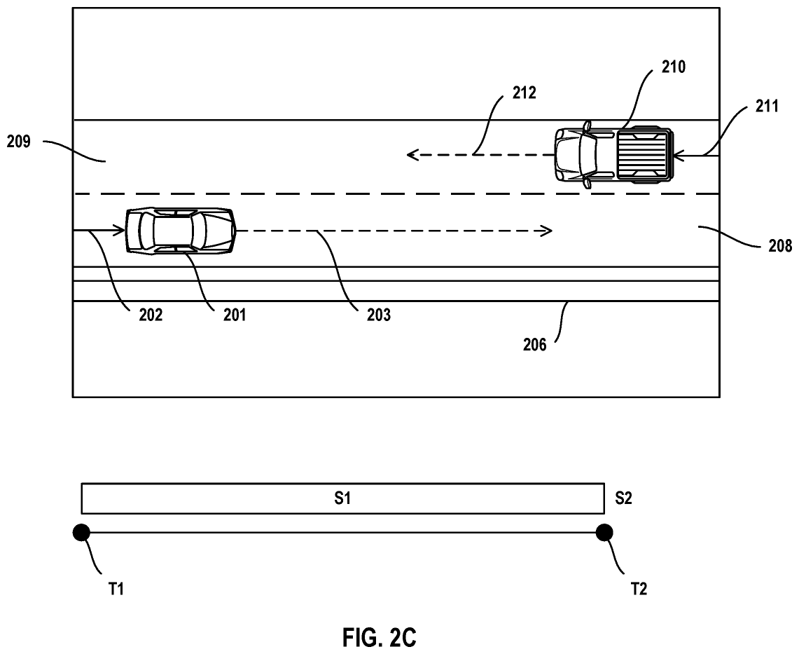

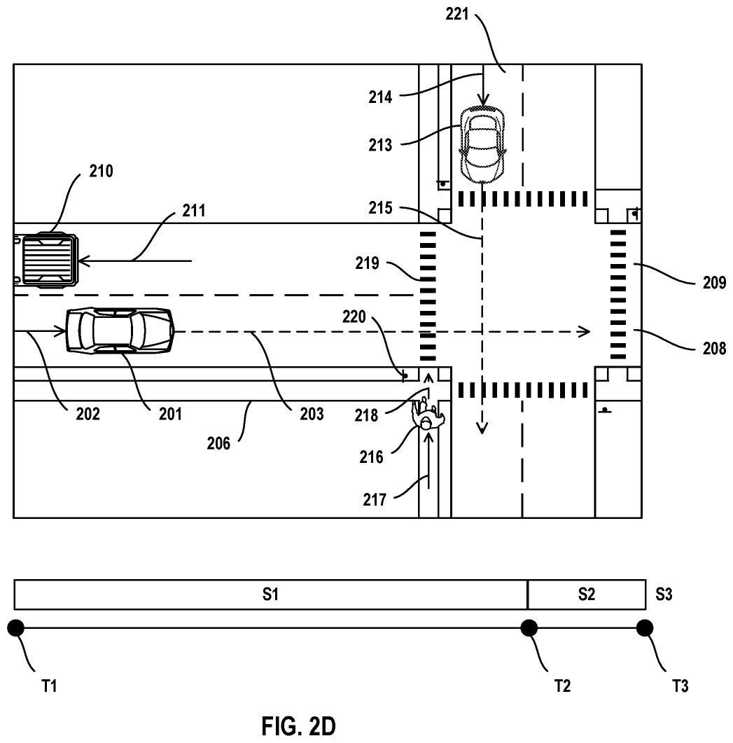

One possible example of using an interaction prediction model to define and generate representations of dynamic scenes is illustrated in FIGS. 2A-2D, which shows vehicle 201 operating on a roadway over a given period of time. As noted above, the information shown in FIGS. 2A-2D, including information related to the vehicle 201 as well as other agents and non-agents in each dynamic scene, may have been obtained from various sources, examples of which may include the vehicle 201 (which may be equipped with sensors and perhaps also software for deriving data from the sensor data captured from such sensors), other agents reflected in the scene(s) (which may be likewise equipped with sensors and perhaps also software for deriving data from the sensor data captured from such sensors), or map data for the area, among other possibilities.

Beginning at FIG. 2A, the surrounding environment of a vehicle 201 is shown at time T1. As shown in FIG. 2A, the vehicle 201 has a past trajectory 202 and planned future trajectory 203. Various non-agent objects are present, including a sidewalk 206 adjacent to the roadway, a tree 207 adjacent to the opposite side of the roadway, as well as the roadway itself, including the lane 208 in which the vehicle 201 is travelling, as well as the adjacent lane 209.

The interaction prediction model may determine that some of these non-agent objects are relevant to the vehicle 201 and some are not. For example, the lane 208 and any driving rules associated with it (e.g., a speed limit, passing restrictions, etc.) may be determined to be relevant to the vehicle 201. In particular, the lane 208, and any changes to it, affects the decision making of the vehicle 201. The same may be true of lane 209, due to its proximity to lane 208. On the other hand, the interaction prediction model may determine that the sidewalk 206 and the tree 207 are not relevant to the future operation of the vehicle 201, as there is a relatively low likelihood of either interacting with the vehicle 201.

Further, FIG. 2A shows that a vehicle 204 has just passed by vehicle 201 travelling in the opposite direction, as shown by the past trajectory 205 of vehicle 204. Based on this information and the predicted future trajectory (not shown) of vehicle 204, the interaction prediction model may determine, based on a relatively low likelihood of interaction during the decision horizon (e.g., less than a relevance threshold), that the vehicle 104 is not considered to be relevant to the vehicle's decision making, and thus the vehicle 204 is no longer part of the decision unit of vehicle 201. Accordingly, time T1 serves as a boundary point that defines a change in the decision unit for the vehicle 201, and correspondingly, the beginning of a new dynamic scene S1 that includes the vehicle 201 and its relevant trajectories, the relevant non-agents noted above, but no other agents.

FIG. 2B shows the vehicle 201 at a later point in time during operation. In FIG. 2B, the vehicle 201 has passed by the tree 207, similar to how the vehicle 201 passed by the vehicle 204 in FIG. 2A. However, the interaction prediction model has already determined that the tree 207 is not relevant to the vehicle 201 and will not be encoded into the eventual representation of dynamic scene S1. Furthermore, none of the non-agent objects determined to be relevant to the vehicle 201, such as the lane 208, have changed in FIG. 2B. Consequently, nothing shown in FIG. 2B results in a relevant change to the decision unit for the vehicle 201, and dynamic scene S1 may continue without the creation of a new boundary point between scenes.

Moving on to FIG. 2C, the vehicle 201 is shown at a still later point in time during operation, at which point its decision unit changes. In particular, the interaction prediction model may determine that an agent, namely vehicle 210 with an associated past trajectory 211 and a predicted future trajectory 212, has become relevant to the vehicle 201. In this regard, it should be understood that the relevance of an agent or non-agent to vehicle 201 does not necessarily correspond to whether or not the vehicle 201 must eventually react to it by, for example, altering its planned trajectory. Rather, the relevance of an agent or non-agent may represent whether the vehicle 201 needs to account for it in its decision making and resulting driving behavior. Thus, although the predicted future trajectory 212 of vehicle 201 may not intersect with the planned future trajectory 203 of the vehicle 201, the vehicle 210 may be within a zone of proximity to the vehicle 201 (e.g., in adjacent lane 209) that requires the vehicle 201 to consider it for potential interactions.

Accordingly, based on the introduction of the vehicle 210 as a relevant agent to the vehicle 201, the interaction prediction model may define a new boundary point T2, and thus the end of dynamic scene S1 and the beginning of dynamic scene S2, as shown in FIG. 2C.

Turning now to FIG. 2D, the vehicle 201 is shown at a still later point in time during operation, at which point the vehicle 201 is approaching a four-way intersection that includes various additional agents and non-agents that become relevant to the vehicle 201. As one example, another vehicle 213 with its own past trajectory 214 and predicted future trajectory 215 may be situated in a lane 221 that crosses the lane 208. As another example, a pedestrian 216 with a past trajectory 217 and a predicted future trajectory 218 may be situated on the sidewalk 206 near the intersection. In this regard, the interaction prediction model may determine that the sidewalk 206, which was formerly determined to be not relevant to the vehicle 201, is now relevant based on the presence of the pedestrian 216, as it may represent the location of one possible future trajectory for the pedestrian 216.

In practice, some of the agents and/or non-agents shown in FIG. 2D may become relevant to the vehicle 201 earlier than others. For instance, the interaction prediction model may determine that the vehicle 213 or the stop sign 220 shown in FIG. 2D should be considered as part of the decision unit of vehicle 201 sooner than the crosswalk 219. However, for ease of illustration and explanation, it may be assumed that each of these new objects is determined to be relevant to the vehicle 201 at approximately the same time shown in FIG. 2D, and further that vehicle 210 is determined to be no longer relevant to the vehicle 201 at approximately the same time. Accordingly, the interaction prediction model may define a new boundary point T3, and thus the end of dynamic scene S2 and the beginning of dynamic scene S3.

Referring to FIGS. 2A-2D, it can be seen that each of dynamic scene S1 and dynamic scene S2, represents a period of operation for the vehicle 201 in which the agents and non-agents that were deemed to be relevant to the decision making and driving behavior of the vehicle 201 did not change. Advantageously, a dynamic scene representation that is generated in this manner encodes the interactions between the vehicle and all relevant agents and non-agents during the scene's time interval within a single, unified data structure. This data structure for each scene can then be indexed and searched, which may provide advantages over approaches that only focus on a vehicle's interactions with agents (but not non-agents), and/or approaches that encode these interactions with agents using a collection of disparate representations of a vehicle's pairwise interaction with only one single other agent of interest, as shown in FIGS. 1A-1B.

As one example of such an advantage, searching for scenes within captured sensor data that include an interaction of interest may become more efficient. For instance, consider a search for all scenes in which a vehicle encountered a pedestrian in a crosswalk, in order to develop a scenario detection model for such an interaction. Using conventional approaches, a query may be executed that searches all the captured sensor data (e.g., every frame of captured sensor data) for occurrences of the pairwise interaction of a vehicle with a pedestrian. This initial search may require substantial computing resources, and moreover, may return results that need to be further refined to remove returned instances of pedestrians that were not in a crosswalk. As another possibility, a complex query may search for occurrences of multiple different pairwise interactions taking place during a given time period, in an attempt to more specifically define a scene of interest. However, such searches may require even more time and computing resources.

On the other hand, the encoded representations of dynamic scenes as discussed herein may include all of the agent and non-agent information that was relevant to a vehicle during a given dynamic scene and may be indexed and searched far more efficiently. For instance, entire dynamic scenes, such as the example dynamic scenes S1 and S2 shown in FIGS. 2A-2D, may not include a pedestrian as a relevant agent, and thus these entire scenes (e.g., including hundreds or thousands of frames of sensor data) may be queried and dismissed as a whole. Similarly, dynamic scenes that do involve pedestrians as relevant agents will also include, as encoded information that may be indexed and searchable, an indication of whether or not the pedestrian was located in a crosswalk. Accordingly, a search for an interaction of this type may be conducted at a scene level, considering entire decision units of a vehicle as a whole, rather than searching by parts using existing approaches. This may provide a substantial improvement in both the speed of searching and the utilization of computing resources.

Another advantage provided by the techniques herein is that, once dynamic scenes are generated in this manner, additional scenes may be generated and evaluated by using one or both of (i) a scene sampling model that functions to generate new “synthetic” scenes based on previously-generated scenes or (ii) a scene prediction model that functions to predict future scenes that are possible evolutions of a previously-generated scene. Each of these will be discussed in further detail below. The disclosed techniques may provide various other advantages as well.

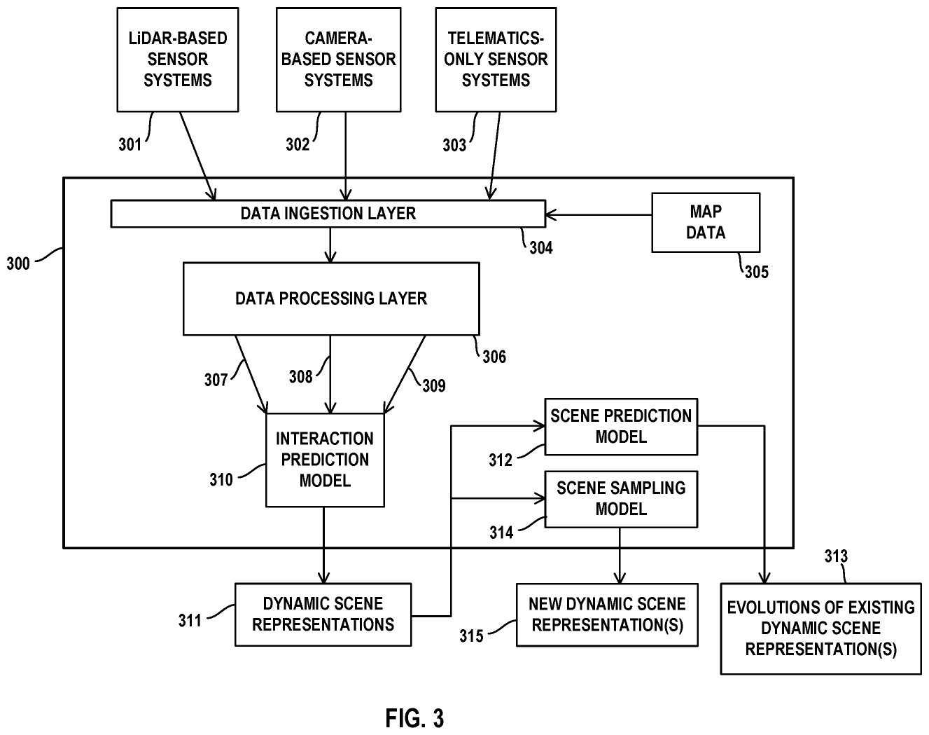

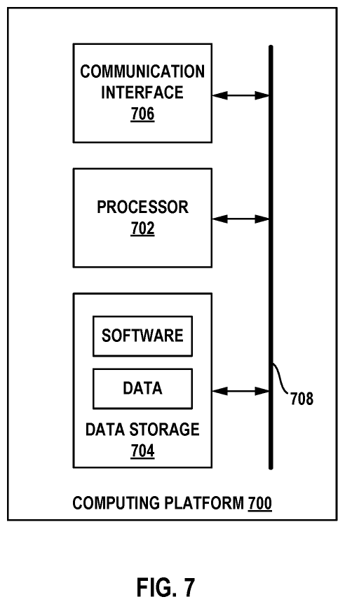

One example of a computing platform 300 and an example data flow pipeline that incorporates the disclosed techniques for generating dynamic scenes is described with reference to FIG. 3. In practice, this example pipeline may be implemented by any computing platform that is capable of obtaining and processing previously-captured sensor data. One possible example of such a computing platform and the structural components thereof is described below with reference to FIG. 7.

As shown in FIG. 3, the data that provides the basis for the different categories of information that are used to define and generate representations of dynamic scenes can be obtained from various different sources and then compiled into one or more repositories that allow such data to be mixed and matched in various ways. In this regard, the data ingestion layer 304 shown in FIG. 3 may take various forms, including one or more data ingestion tools that process and prepare the incoming data for use by other components of the computing platform 300.

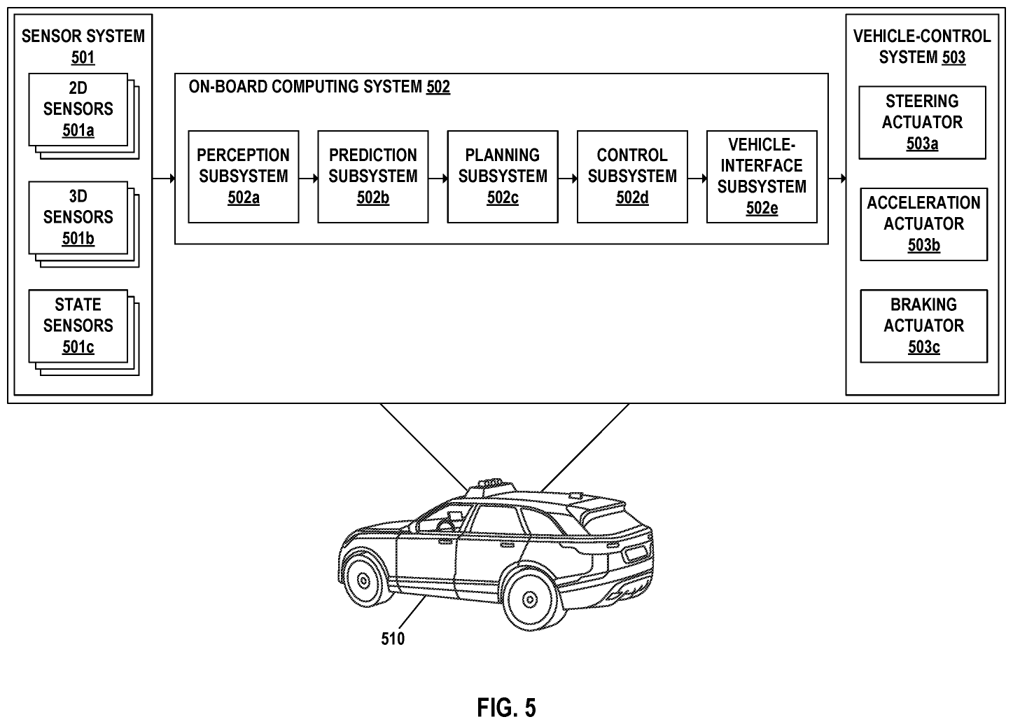

As one possible data source, sensor data may be obtained from one or more LiDAR-based sensor systems 301 that may be in operation as part of an on-vehicle computing system, which may comprise a LiDAR unit combined with one or more cameras and/or telematics sensors. One possible example of such a LiDAR-based sensor system is described below with reference to FIG. 5. In general, sensor data obtained from a LiDAR-based sensor system may have a relatively high degree of accuracy but may be less readily available due to the limited implementation of such sensor systems to date.

As another possibility, sensor data may be obtained from one or more camera-based sensor systems 302 that may be in operation on one or more vehicles, which may comprise one or more monocular and/or stereo cameras combined with one or more telematics sensors. Such sensor data may have an intermediate degree of accuracy as compared to LiDAR-based sensor systems but may be more readily available due to the greater number of camera-based sensor systems in operation.

As another possibility, sensor data may be obtained from one or more telematics-only sensor systems 303, which may comprise one or more telematics sensors such as a GPS unit and/or an inertial measurement unit (IMU). Such telematics-only sensor data may have a relatively lower degree of accuracy as compared to data captured by LiDAR-based and camera-based sensor systems. However, telematics-only sensor data may be much more abundant, as such sensor systems may be in operation on numerous vehicles, including perhaps a fleet of vehicles operating as part of a transportation matching platform.

As another possibility, map data 305 corresponding to the geographic area in which the ingested sensor data was captured may be incorporated as part of the data ingestion layer 304. In some examples, the map data 305 may be obtained from a repository of such data that is incorporated with computing platform 300, as shown in FIG. 3. Additionally or alternatively, the map data 305 may be stored separately from the computing platform 305. In some other examples, the map data 305 may be derived by the computing platform 300 based on the sensor data that is ingested from one or more of the sensor systems discussed above.

Although three example types of sensor systems have been discussed above, it should be understood that the possible data sources may include any system of one or more sensors, embodied in any form, that is capable of capturing sensor data that is representative of the location and/or movement of objects in the real world—including a system comprising any one or more of a LiDAR unit, a monocular camera, a stereo camera, a GPS unit, an IMU, a Sound Navigation and Ranging (SONAR) unit, and/or a Radio Detection And Ranging (RADAR) unit, among other possible types of sensors. Additionally, while the example sensor systems above are described as being affixed to ground-based vehicles, it should be understood that the sources may include sensor systems that are affixed to other types of agents (such as drones or humans) as well as sensor systems affixed to non-agents (e.g., traffic lights). Various other data sources and data types are also possible, including data that was derived from other sensor data (e.g., vehicle trajectory data) and/or simulated data sources.

In this regard, it will be also appreciated that a given data source might not provide information related to all of the categories of information that are used to generate dynamic scenes. For example, a telematics-only sensor system will capture sensor data that only provides information about the vehicle with which the sensor system was co-located, but not information about other agents or non-agents surrounding that vehicle. Conversely, another sensor system may collect sensor data that provides information about non-agent objects, but not information about a decision-making vehicle of interest or other surrounding agents.

The computing platform 300 may further include a data processing layer 306 that transforms or otherwise processes the ingested data into a form that may be used for defining and generating representations of dynamic scenes. In this regard, the data processing layer 306 may derive past trajectories and predicted future trajectories for vehicles and their surrounding agents based on the ingested data. For instance, the data processing layer 306 may derive past trajectories for vehicles and other agents from sensor data using any of various techniques, which may depend in part on the type of sensor data from which the trajectory is being derived.

As one possibility, if the sensor data is obtained from a LiDAR-based sensor system, a simultaneous location and mapping (SLAM) localization technique may be applied in order to localize the vehicle within a LiDAR-based map for the area in which the vehicle was operating. As another possibility, if the sensor data is obtained from a camera-based sensor system, a simultaneous location and mapping (SLAM) localization technique (e.g., visual SLAM) may be applied in order to localize the vehicle within an image-based map for the area in which the vehicle was operating. As yet another possibility, if the sensor data is obtained from a telematics-only sensor system, a map-matching localization technique may be applied in order to localize the vehicle within a road-network map for the area in which the vehicle was operating. The technique used to derive past trajectories for a given vehicle or agent may take other forms as well.

In this regard, compiling data and deriving additional data from various different types of sensor systems, on different vehicles, operating in different environments, as well as other types of data sources, may present a host of challenges due to the different source-specific coordinate frames in which such data was captured, as well as the different degrees of accuracy (or sometimes referred to as “quality”) associated with each type of sensor data. However, techniques have been developed that provide for deriving and storing trajectories (and other types of data) that are represented according to a source-agnostic coordinate frame, such as an Earth-centered Earth-fixed (ECEF) coordinate frame, as opposed to source-specific coordinate frames that are associated with the various different sources of the sensor data from which the trajectories are derived. Such techniques are described in more detail in U.S. application Ser. No. 16/938,530, which is hereby incorporated by reference in its entirety.

In addition to deriving past trajectories, the data processing layer 306 may utilize one or more variable acceleration models or the like to propagate past vehicle and agent trajectories forward in time based in part on the past trajectory information (e.g., position, orientation, velocity, etc.), map data (e.g., lane boundaries, traffic rules), and/or other data that may have been ingested or derived by the data ingestion layer 304. Such trajectories may be represented and stored according to a source-agnostic coordinate frame, as noted above. Predicted future trajectories may be derived for vehicles and agents in various other manners as well.

In some implementations, the data processing layer 306 may also function to fill in gaps that may be present in the obtained sensor data by compiling and using all available data for the relevant location and time to represent the trajectories of the vehicle and agents. For example, as noted above, sensor data from a telematics-only sensor system may include trajectory information for a given vehicle, but may be lacking any information regarding other agents or non-agent objects perceived by the vehicle during a period of operation. In this situation, the telematics-only vehicle trajectories may be supplemented with other data regarding agent trajectories and non-agent object information from the same location and time.

In some further implementations, there may not be sufficient sensor data for a particular location and time to assemble a sufficiently detailed representation of a vehicle's surrounding environment, even when all sources are considered. In these situations, the data processing layer 306 may generate synthetic agent trajectory information and/or non-agent information that may be extrapolated based on the sensor data that is available for a given agent or non-agent object. As another possibility, the data processing layer 306 may generate synthetic agent trajectory information or non-agent information based on sensor data captured at other times and locations in order to fill in the vehicle's period of operating with such data.

In line with the discussion above, the data processing layer 306 may generate, for each of various times during a vehicle's period of operation, vehicle trajectory information 307, agent trajectory information 308, and non-agent object information 309, all of which may be used as inputs to an interaction prediction model 310, as shown in FIG. 3. As discussed above with reference to FIGS. 2A-2D, the interaction prediction model 310 may determine the likelihood of interaction between the vehicle and each of the agents and non-agents in its surrounding environment, and then determine for each whether the likelihood exceeds a relevance threshold.

The interaction prediction model 310 may determine a vehicle's likelihood of interaction with a given object in various manners, which may depend on the type of object in question. For example, a vehicle's likelihood of interaction with an agent vehicle may be determined based on respective trajectories of the two vehicles (e.g., including respective positions, orientations, velocities, and accelerations) that were derived by the data processing layer 306, as well as non-agent information such as lane boundaries and traffic rules, among other possibilities. Based on these considerations, an agent vehicle that is travelling on the opposite side of the road, or perhaps on the same side of the road but separated by several lanes from a given vehicle, may be determined to have a lower likelihood of interaction with the given vehicle than an agent vehicle that is travelling in the same lane or an adjacent lane to the given vehicle.

As another example, a vehicle's likelihood of interaction with an agent pedestrian may be determined based on similar information that is derived by the data processing layer 306, including the respective trajectories of the vehicle and the pedestrian and relevant non-agent data, such as crosswalks, traffic control signals, and the like. Accordingly, pedestrians having a predicted trajectory that is proximate to the planned trajectory of the vehicle may be determined to have a higher likelihood of interaction with the vehicle than pedestrians whose predicted trajectories are relatively distant from that of the vehicle.

Further, the interaction prediction model may additionally take into account the interactions between other agents and non-agents, as these interactions may have a downstream effect on the eventual interactions of these other agents and non-agents with the vehicle.

As yet another example, a vehicle's likelihood of interaction with a non-agent object, such as a traffic sign or a traffic signal, may be based on the trajectory of the vehicle and the position and perhaps orientation of the non-agent, in addition to other information about the non-agent, where relevant. For instance, map data associated with a non-agent traffic signal may include semantic information indicating a position, orientation, and traffic lane that is controlled by the traffic signal. This data may be compared with the vehicle's predicted trajectory, including the vehicle's position, direction of travel, and lane position, among other information.

The interaction prediction model 310 may consider numerous other types of information to determine the likelihood of a vehicle's interaction with a given agent or non-agent as well.

In line with the discussion above, the interaction prediction model 310 may then determine, based on the determined likelihood of interaction between the vehicle and the agent or non-agent in question, whether the agent or non-agent is relevant to the decision making of the vehicle. This may involve comparing the determined likelihood of interaction to a relevance threshold. In some implementations, the determined likelihood of interaction may be a probability that is expressed as a percentage, and the relevance threshold may be a threshold percentage, such as 5%. Thus, any agents or non-agents that are determined to be less than 5% likely to interact with the vehicle are deemed not relevant to the vehicle's decision-making. On the other hand, agents or non-agents that are determined to be greater than 5% likely (e.g., 5% or more) to interact with the vehicle are deemed to be relevant to the vehicle's decision-making. Other relevance thresholds are also possible, including other percentages, as well as thresholds that are expressed in other ways.

As noted above, sensor data obtained from different data sources (e.g., different types of sensor systems) may be associated with different degrees of accuracy, a representation of which may be maintained with the data when it is represented in the source-agnostic coordinate frame. In turn, the respective degree of accuracy of any information that contributes to a given trajectory may translate to a degree of confidence associated with that information. For example, a predicted future agent trajectory, such as any of the predicted future agent trajectories shown in FIGS. 2A-2D, may have a probability associated with it (e.g., 40% confidence vs. 90% confidence that the agent will follow the predicted trajectory). This, in turn, may factor into the determination of the agent's likelihood of interaction with a vehicle, and thus the relevance of the agent to the vehicle's decision making. For instance, a vehicle may plan differently when an agent within its surrounding environment has a predicted trajectory with a 40% degree of confidence vs. a trajectory with a 90% degree of confidence.

Based on the determination of each object's relevance, the interaction prediction model 310 may identify one or more points in time during the vehicle's period of operation when there is a change to the agents or non-agents that are determined to be relevant to the decision making of the vehicle. In this regard, a change to agents or non-agents that are relevant to the vehicle may involve the determination that a new agent or non-agent that is relevant to the vehicle, or that an agent or non-agent that was formerly relevant at an earlier point in time is no longer relevant to the vehicle. Several examples of such changes to the agents and non-agents that are relevant to a vehicle are discussed above with respect to FIGS. 2A-2D.

Each identified point in time that involves a change to the relevant agents or non-agents may be designated as a boundary point between two dynamic scenes for the vehicle. Accordingly, the interaction prediction model may divide a given period of operation of a vehicle into a series of dynamic scenes, each of which is defined by a pair of consecutive boundary points the designate changes to the agents and non-agents that were relevant to the vehicle's decision making. Put another way, each dynamic scene represents a time interval during the period of operation of the vehicle when there were no changes to the agents or non-agents that affected the vehicle's decision making. Thus, each dynamic scene may represent a discrete decision unit for the vehicle.

Once the dynamic scenes are defined in this way, the interaction prediction model 310 may generate a dynamic scene representation 311 that encodes the interactions between the vehicle and all relevant agents and non-agents during each scene's time interval within a single data structure that can subsequently be indexed and searched, giving rise to the advantages discussed above.

In some implementations, additional models may be utilized to generate and evaluate new scenes based on existing dynamic scene representations. Such scenes may be referred to as “synthetic” scenes as they do not correspond to a dynamic scene that was actually encountered by a vehicle, but nonetheless represent scenes that are logical evolutions of, or combinations of, dynamic scenes that were actually encountered by the vehicle. This may be beneficial as it expands the universe of interactions between vehicles and agents/non-agents that are included within the generated set of dynamic scene representations.

In a first implementation, a previously generated dynamic scene representation 311 may be provided as input to a scene prediction model 312 that may be used to generate new scenes 313 that are evolutions in time of the previously generated dynamic scene.

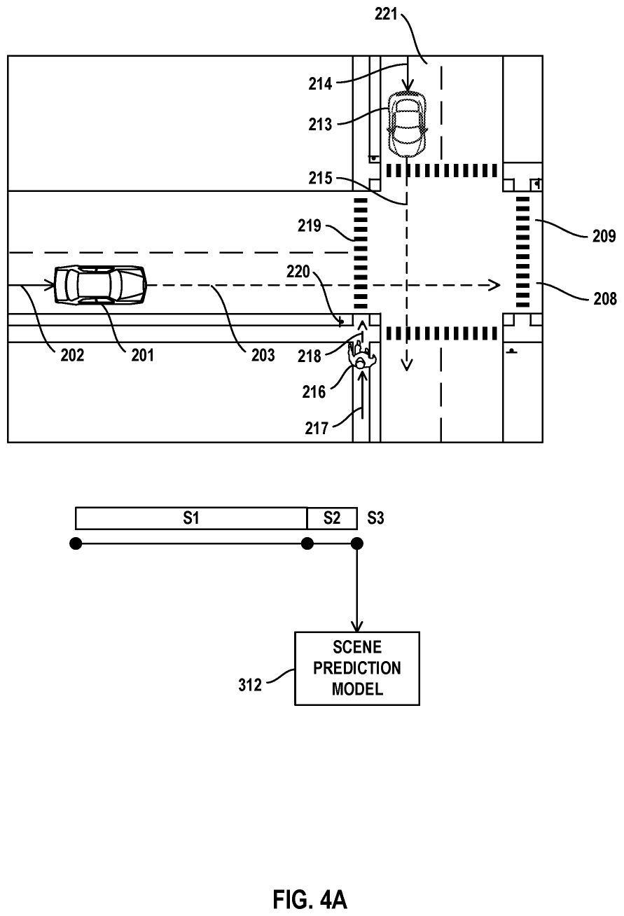

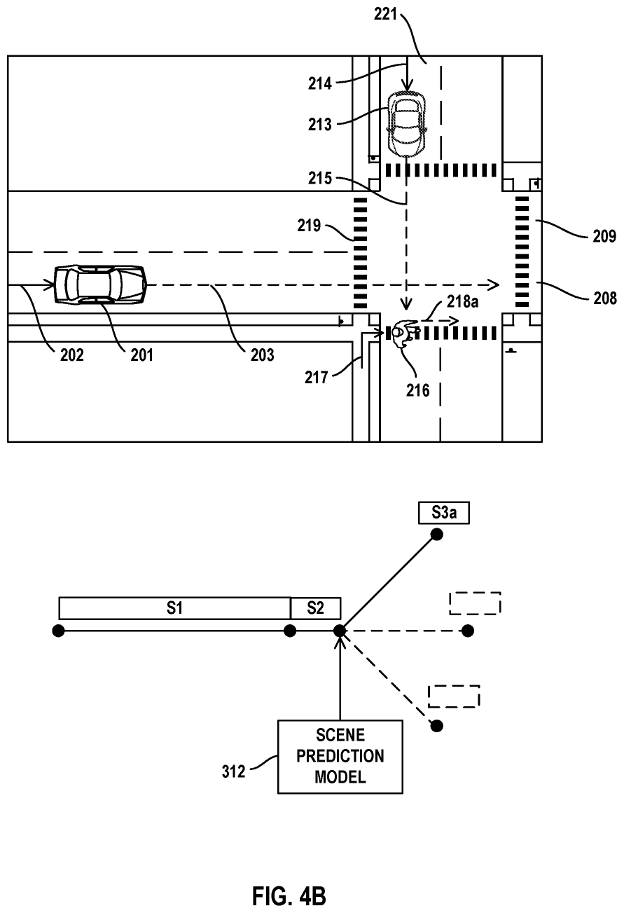

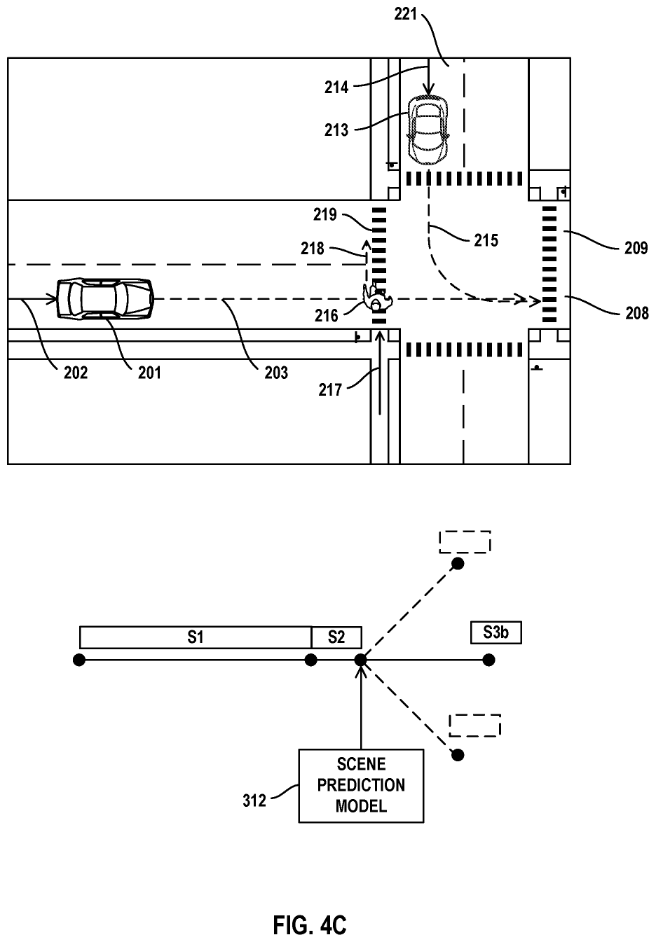

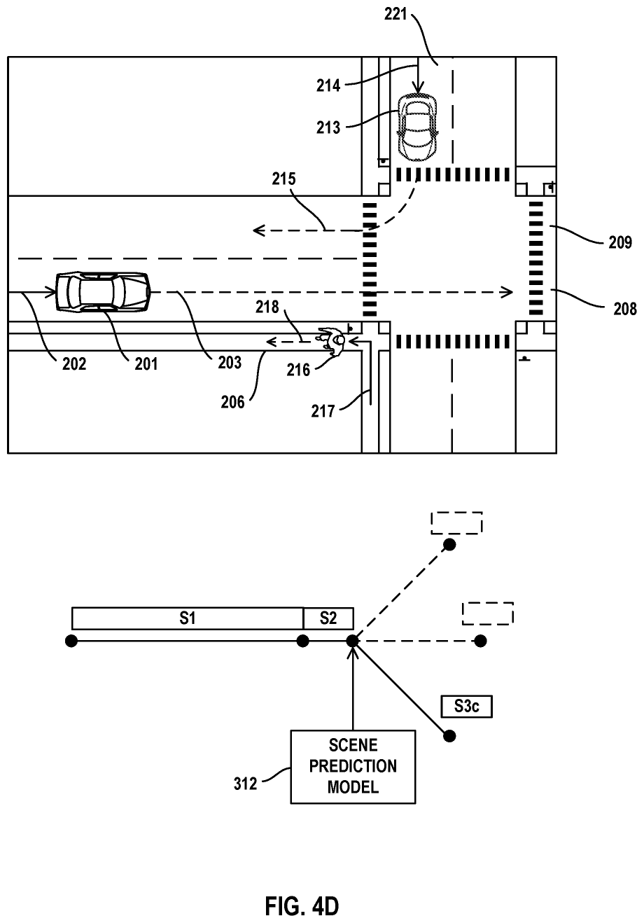

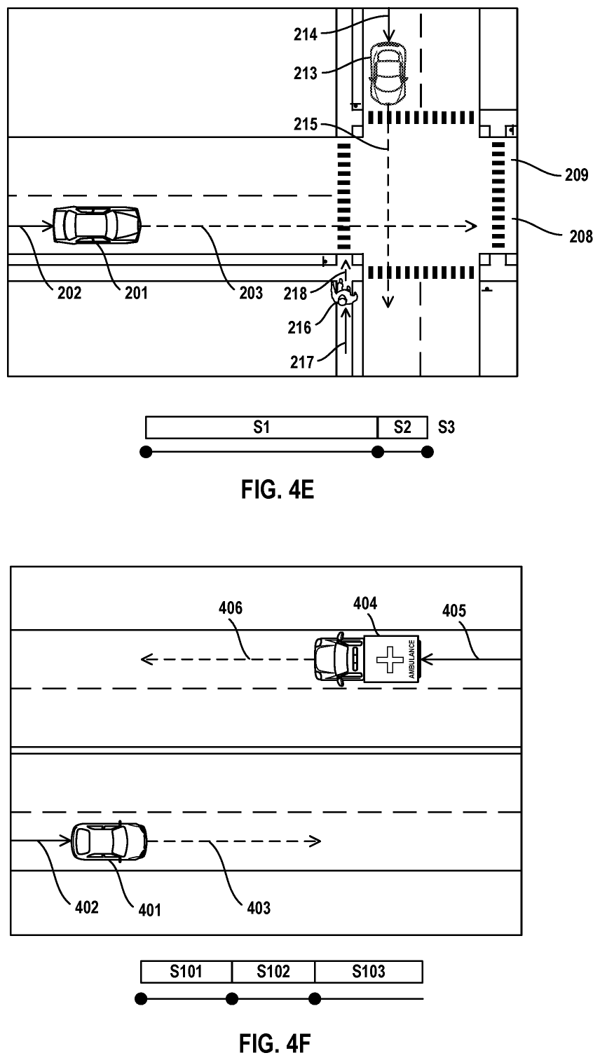

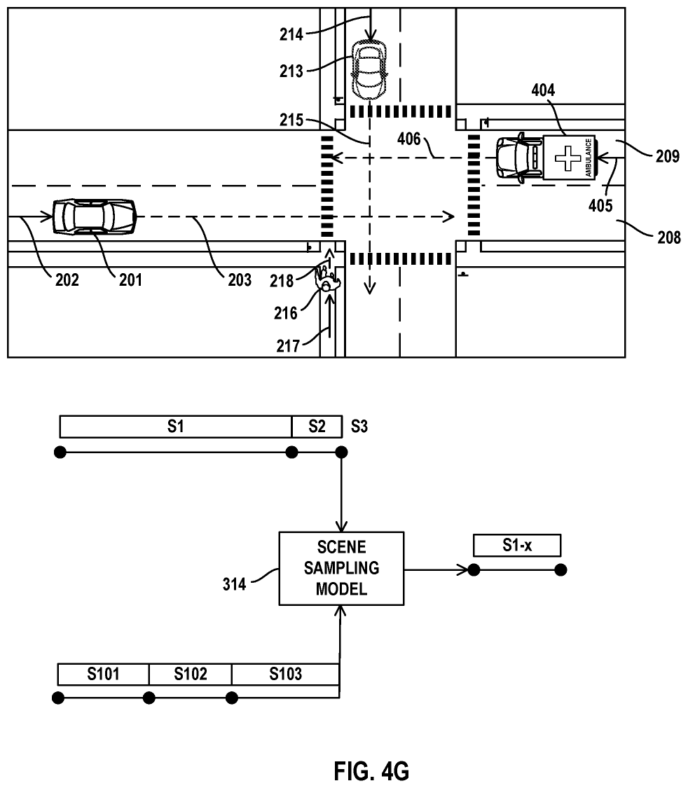

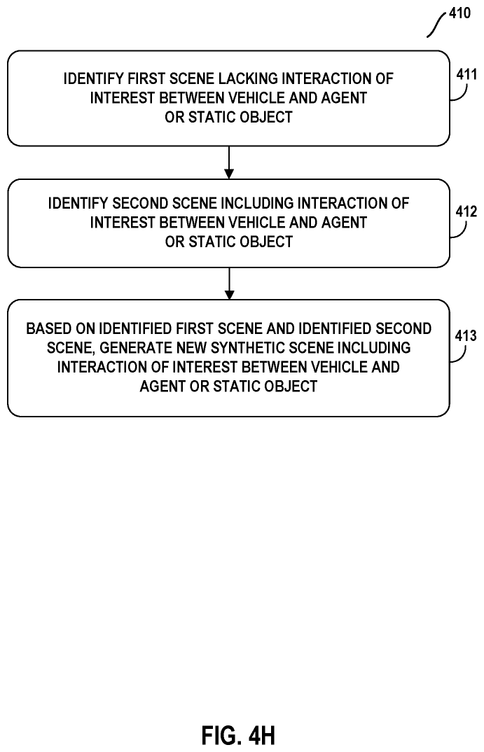

One possible example of utilizing the scene prediction model 312 in this way is illustrated in FIGS. 4A-4D. Beginning with FIG. 4A, the vehicle 201 shown in FIG. 2D is illustrated at a boundary point between dynamic scene S2, which has just concluded, and a new dynamic scene S3. Similar to FIG. 2D, the vehicle 201 has a past trajectory 202 and a planned future trajectory 203 that sees it continuing to travel straight in traffic lane 208, including stopping temporarily at stop sign 220. Two additional agents are shown, including the pedestrian 216 with a past trajectory 217 and a predicted future trajectory that sees the pedestrian 216 continue straight into crosswalk 219. Further, the vehicle 213 includes the past trajectory 214 and a predicted future trajectory 215 that sees the vehicle 213 continuing to travel straight in traffic lane 221, as discussed with respect to FIG. 2D.

Accordingly, all of this information regarding the vehicle 201 and the agents and non-agents relevant to vehicle 201 may be provided to the scene prediction model 312 to generate different possible variations of dynamic scene S3 as an evolution of dynamic scene S2. In a first example that is illustrated in FIG. 4B, the pedestrian 216 may not continue travelling straight into crosswalk 219 as originally predicted. Instead, the pedestrian 216 may turn right into the lane 221, with a new predicted future trajectory 218a. This, in turn may result in a dynamic scene S3a which differs from the dynamic scene S3 that was originally predicted. In particular, vehicle 213 may now have to account for the pedestrian 216, whereas originally it did not. This, in turn, may have a downstream effect on the decision making and planning behavior of the vehicle 201. For example, the pedestrian 216 is no longer predicted to cross traffic lane 208 in the crosswalk 219, and thus the vehicle 201 may not need to account for the pedestrian crossing in its planned behavior. However, the pedestrian 216 may instead delay the time that it would have otherwise taken for the vehicle 213 to proceed through the intersection, which may extend the time that vehicle 213 remains relevant to vehicle 201. Other differences that may result from the variation shown in FIG. 4B are also possible.

Another example scene that may be generated by the scene prediction model 312 as an evolution of dynamic scene S2 is illustrated in FIG. 4C, wherein the pedestrian 216 proceeds to cross the crosswalk 219 as predicted, but the vehicle 213 makes a left turn into traffic lane 208 instead of continuing to travel straight in traffic lane 221. The resulting dynamic scene S3b may result in additional variations to the decision making of vehicle 201 that were not present in either originally planned dynamic scene S3 nor dynamic scene S3a. In particular, the vehicle 201 and the vehicle 213 both have future trajectories that will put them in the same traffic lane, which may require a greater amount of planning to avoid conflicts. Further, the vehicle 213 may remain relevant to the vehicle 201 after both vehicles have cleared the intersection, the vehicle 213 will likely now be a lead vehicle travelling in front of the vehicle 201.

Yet another example scene that may be generated by the scene prediction model 312 as an evolution of dynamic scene S2 is illustrated in FIG. 4D, where neither the pedestrian 216 nor the vehicle 213 proceeds according to their originally predicted trajectory. Instead, the pedestrian 216 turns left and travels along sidewalk 206 where the pedestrian will not interact with either of vehicle 201 or vehicle 213. Similarly, vehicle 213 turns right into traffic lane 209 instead of continuing to travel straight and will not interact with either the pedestrian 216 or the vehicle 101. Accordingly, the resulting dynamic scene S3c may result in additional variations to the decision making of vehicle 201. For instance, in some cases, the pedestrian 216 may be considered to be no longer relevant to the vehicle 201 such that the pedestrian 216 leaves the decision horizon of vehicle 201. Accordingly, the representation of dynamic scene S3c may not include the pedestrian 216 as a relevant agent. Further, although the vehicle 213 may remain within the decision horizon of vehicle 201 due to its proximity, the vehicle 201 may not need to plan for any interactions with vehicle 213 as vehicle 201 crosses the intersection.

The examples shown in FIGS. 4B-4D represent three different variations, or branches, that may extend from the end of dynamic scene S2. However, numerous other branches are also possible, involving different combinations of interactions between the vehicle 201 and the agents discussed above, or other agents and non-agents. Additionally, the confidence level associated with aspects of a given scene may provide an additional variable to be used for the creation of different scenes. For instance, the same time sequence of positions may be used to represent an agent's predicted trajectory across three different scenes, but the confidence level of the predicted trajectory in each scene may vary from 30% to 60% to 90%, resulting in different vehicle behaviors. Further, it will be appreciated that this type of analysis of different scene possibilities may proceed from any given point in time during a vehicle's period of operation, and is not limited to an analysis at boundary points between dynamic scenes as presented above.

In another implementation, referring again to FIG. 3, two or more previously generated dynamic scene representations 311 may be provided as inputs to a scene sampling model 314 that may be used to generate and explore new dynamic scene representations 315 that may not be otherwise represented in the obtained sensor data. As above, this may be beneficial as it expands the universe of interactions between vehicles and agents/non-agents that are included within the generated set of dynamic scene representations.

Indeed, a wide range of synthetic scenes may be created by mixing and matching different combinations of 1) vehicle trajectories, 2) agent trajectories, and 3) non-agent information from across any of the different sources discussed above, among other sources. Advantageously, a synthetic scene of this kind does not need to be built with sensor data from the same time or location. Rather, it may be possible to build synthetic scenes for one time/location from a combination of sensor data from that time/location and sensor data from other times/locations (e.g., “geo-transferred” sensor data).

Other types of synthetic scene generation are also possible. For instance, the information obtained from the various data sources may be modeled as a distribution (e.g., a multivariate distribution) that reflects the differences in the information across several different variables. The distribution may then be randomly sampled to generate new synthetic scenes, each of which may include different combinations of the information reflected in the distribution. Indeed, synthetic scenes that are created in this way may produce synthetic vehicle trajectories, agent trajectories, and non-agent information that is not reflected in the data obtained directly from the data sources.

Synthetic scenes may be generated in various other manners as well.

One possible example of using a scene sampling model 314 to generate a new scene that is a combination of aspects of previously generated dynamic scenes is illustrated in FIGS. 4E-4H. As shown in FIG. 4E, the vehicle 201 shown in FIG. 2D is illustrated at a boundary point between dynamic scene S2, which has just concluded, and a new dynamic scene S3. In this regard, FIG. 4E may illustrate the same point in time during the period of operation of vehicle 201 that is shown in FIG. 4A.

As noted above, certain types of less common interactions may be under-represented within the captured sensor data, such as scenes in which a human-driven vehicle encounters an emergency vehicle at a four-way intersection, such as the intersection shown in FIG. 4E. Accordingly, information from different dynamic scenes, encountered by a different vehicle at a different location, that includes this under-represented interaction may be used to create a synthetic scene to explore how the decision making of vehicle 201 may behave in such situations.

FIG. 4F shows one possible example of a different scene that includes the under-represented interaction. For instance, FIG. 4F illustrates a different vehicle 401, including a past trajectory 402 and a planned future trajectory 403. Prior changes to the decision horizon of vehicle 401 are reflected in FIG. 4F, as shown by the boundary points dividing dynamic scenes S101, S102, and S103. At the point in time shown in FIG. 4F, the vehicle 401 is in the midst of dynamic scene S103 that includes an emergency vehicle 404 with its own past trajectory 405 and predicted future trajectory 406. In line with the discussion above, the interaction prediction model 310 may have determined that various non-agent objects are relevant to dynamic scene S103, including the roadway, lane boundaries, and traffic rules in the area shown in FIG. 4F. Further, the interaction prediction model 310 may have additionally determined that the emergency vehicle 404 is relevant to vehicle 401. In particular, although the emergency vehicle 404 is several lanes removed from the vehicle 401 and moving in the opposite direction, emergency vehicles often do not adhere to established lane boundaries or other driving rules. As a result, the level of confidence associated with the predicted future trajectory 406 of emergency vehicle 404 may not be as high as it otherwise would for a typical vehicle, and thus the vehicle 401 may continue to account for the emergency vehicle 404 in its decision making operations (e.g., the vehicle 401 may elect not to change lanes during dynamic scene S103 and thereby move closer to the predicted future trajectory 406 of emergency vehicle 404).

In line with the discussion above, FIG. 4G illustrates the dynamic scene representation shown in FIG. 4E and the dynamic scene representation shown in FIG. 4F being input into the scene sampling model 314. Based on the respective vehicle, agent, and non-agent information from the two inputs, the scene sampling model 314 generates a new dynamic scene S1-x, which is depicted in FIG. 4G. In particular, new dynamic scene S1-x includes the vehicle 201 and the other agents, non-agents and associated information shown in FIG. 4E, but also includes the emergency vehicle 404 from FIG. 4F now positioned in traffic lane 209.

As opposed to the synthetic scenes that were generated using the scene prediction model 312 in FIGS. 4B-4D, it should be appreciated that dynamic scene S1-x generated by the scene sampling model 314 is not an evolution of either of the “parent” scenes shown in FIG. 4E or FIG. 4F. In this regard, the dynamic scene S1-x presents numerous potential interactions between combinations of agents and non-agents that are not present, or even possible, in FIG. 4E or FIG. 4F. Rather, dynamic scene S1-x represents a new “branch” of dynamic scenes that includes information that is not otherwise represented in the collected sensor data. Moreover, dynamic scene S1-x and other scenes generated by the scene sampling model 314 can be further explored using the scene prediction model 312, as discussed above in relation to FIGS. 4A-4D.

FIG. 4H illustrates a functional block diagram 410 that illustrates one example of the functions that may be carried out using the scene sampling model 314, as discussed in the example of FIGS. 4E-4G above. At block 411, the scene sampling model 314 may identify, from a set of previously generated dynamic scene representations, a first scene that lacks an interaction of interest between the vehicle and a particular agent or static object, as discussed above with respect to FIG. 4E. At block 412, the scene sampling model 314 may identify a second scene from the set of previously generated dynamic scene representations that includes the interaction of interest. In this regard, the first scene that lacks the interaction of interest may be identified based on additional criteria of interest. For example, the first scene may be identified based on its inclusion of a particular agent or non-agent, such as a pedestrian, in order to generate a synthetic scene that includes both a pedestrian and the particular agent or static object of interest. Various other examples of criteria that may be used for identifying the first and second scenes are also possible.

At block 413, based on the identified first scene and the identified second scene, the scene sampling model 314 may generate a new synthetic scene that includes the interaction of interest between the vehicle and the particular agent or static object. As discussed above, with respect to FIG. 4G, the new synthetic scene may include interactions that are not otherwise reflected in the captured sensor data or within any other dynamic scene representation.

Thus, by using the data-driven approaches discussed herein, the resulting dynamic scenes and the encoded representations thereof may fill in gaps in the collected sensor data, resulting in a more comprehensive repository of scene information. Further, a dynamic scene representation provides a unified representation of a scene that can be indexed and queried more efficiently. Further, the dynamic scenes discussed herein are defined in a more intelligent way that tracks a driver's decision making, which gives rise to a host benefits, including improvements in the accuracy and/or performance of actions that are taken based on the dynamic scenes. Various other techniques for defining dynamic scenes and generating new dynamic scenes consistent with the discussion above are also possible.

As noted above, the scene information discussed herein may be used for various purposes. In most cases, these uses involve searching a repository of dynamics scenes for one or more scenarios of interest. Accordingly, the advantages discussed above related to searching for particular interactions within collected sensor data at a scene-wide level may be realized in each case.

As one possibility, dynamic scenes may be used to train scenario detection models for use by an on-board computing system of an autonomous or semi-autonomous vehicle and/or by vehicles operating as part of a transportation matching platform. For example, a repository of dynamic scenes may be queried for a given interaction of interest, and the identified dynamic scene representations may be used as input to train a scenario detection model for the interaction of interest. Thereafter, the model may be utilized by an on-board computing system of a vehicle to detect that the vehicle has encountered the interaction of interest, and then adjust its planned trajectory in a way that properly accounts for that detected interaction. As another example, the dynamic scene representations identified by a query may be presented to humans that are tasked with reviewing and labeling the sensor data associated with the dynamic scenes. A machine learning technique may then be applied to the labeled sensor data in order to train such scenario detection models.

As another possibility, dynamic scenes may be used to evaluate technology employed by on-vehicle computing systems. For example, once a vehicle's period of operation is broken down into a series of dynamic scenes, the vehicle's behavior in a given scene may be compared against the behavior of human drivers in dynamic scenes of a similar type within the repository of dynamic scenes.

As another possibility, dynamic scenes may be used to generate aspects of maps. As one example, the repository of dynamic scenes may be queried for dynamic scenes that encode vehicle trajectories across numerous examples of a given type of roadway intersection. This information may then be used to create geometry information for junction lanes (e.g., the lanes that a vehicle should follow within an intersection, which might not be indicated by painted lane lines) that are to be encoded into a map being built that includes an intersection of the given type. This map may then be used by on-board computing systems of vehicles and/or transportation matching platforms.

Various other uses for the dynamic scenes discussed herein are also possible.

As noted above, the dynamic scene representations that are generated using the disclosed techniques may be used to train scenario detection models and evaluate technology employed by on-vehicle computing systems, among other possibilities, in order to improve the operation of such systems and the vehicles that employ them. In view of this, one possible example of such a vehicle will now be discussed in greater detail.

Turning now to FIG. 5, a simplified block diagram is provided to illustrate certain systems that may be included in an example vehicle 500. As shown, at a high level, vehicle 500 may include at least (i) a sensor system 501 that is configured to capture sensor data that is representative of the real-world environment being perceived by the vehicle (i.e., the collection vehicle's “surrounding environment”) and/or the collection vehicle's operation within that real-world environment, (ii) an on-board computing system 502 that is configured to perform functions related to autonomous operation of vehicle 500 (and perhaps other functions as well), and (iii) a vehicle-control system 503 that is configured to control the physical operation of vehicle 500, among other possibilities. Each of these systems may take various forms.

In general, sensor system 501 may comprise any of various different types of sensors, each of which is generally configured to detect one or more particular stimuli based on vehicle 500 operating in a real-world environment. The sensors then output sensor data that is indicative of one or more measured values of the one or more stimuli at one or more capture times (which may each comprise a single instant of time or a range of times).

For instance, as one possibility, sensor system 501 may include one or more 2D sensors 501a that are each configured to capture 2D sensor data that is representative of the vehicle's surrounding environment. Examples of 2D sensor(s) 501a may include a single 2D camera, a 2D camera array, a 2D RADAR unit, a 2D SONAR unit, a 2D ultrasound unit, a 2D scanner, and/or 2D sensors equipped with visible-light and/or infrared sensing capabilities, among other possibilities. Further, in an example implementation, 2D sensor(s) 501a may have an arrangement that is capable of capturing 2D sensor data representing a 360° view of the vehicle's surrounding environment, one example of which may take the form of an array of 6-7 cameras that each have a different capture angle. Other 2D sensor arrangements are also possible.

As another possibility, sensor system 501 may include one or more 3D sensors 501b that are each configured to capture 3D sensor data that is representative of the vehicle's surrounding environment. Examples of 3D sensor(s) 501b may include a LiDAR unit, a 3D RADAR unit, a 3D SONAR unit, a 3D ultrasound unit, and a camera array equipped for stereo vision, among other possibilities. Further, in an example implementation, 3D sensor(s) 501b may comprise an arrangement that is capable of capturing 3D sensor data representing a 360° view of the vehicle's surrounding environment, one example of which may take the form of a LiDAR unit that is configured to rotate 360° around its installation axis. Other 3D sensor arrangements are also possible.

As yet another possibility, sensor system 501 may include one or more state sensors 501c that are each configured capture sensor data that is indicative of aspects of the vehicle's current state, such as the vehicle's current position, current orientation (e.g., heading/yaw, pitch, and/or roll), current velocity, and/or current acceleration of vehicle 500. Examples of state sensor(s) 501c may include an IMU (which may be comprised of accelerometers, gyroscopes, and/or magnetometers), an Inertial Navigation System (INS), a Global Navigation Satellite System (GNSS) unit such as a GPS unit, among other possibilities.

Sensor system 501 may include various other types of sensors as well.

In turn, on-board computing system 502 may generally comprise any computing system that includes at least a communication interface, a processor, and data storage, where such components may either be part of a single physical computing device or be distributed across a plurality of physical computing devices that are interconnected together via a communication link. Each of these components may take various forms.

For instance, the communication interface of on-board computing system 502 may take the form of any one or more interfaces that facilitate communication with other systems of vehicle 500 (e.g., sensor system 501, vehicle-control system 503, etc.) and/or remote computing systems (e.g., a transportation-matching system), among other possibilities. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols.

Further, the processor of on-board computing system 502 may comprise one or more processor components, each of which may take the form of a general-purpose processor (e.g., a microprocessor), a special-purpose processor (e.g., an application-specific integrated circuit, a digital signal processor, a graphics processing unit, a vision processing unit, etc.), a programmable logic device (e.g., a field-programmable gate array), or a controller (e.g., a microcontroller), among other possibilities.

Further yet, the data storage of on-board computing system 502 may comprise one or more non-transitory computer-readable mediums, each of which may take the form of a volatile medium (e.g., random-access memory, a register, a cache, a buffer, etc.) or a non-volatile medium (e.g., read-only memory, a hard-disk drive, a solid-state drive, flash memory, an optical disk, etc.), and these one or more non-transitory computer-readable mediums may be capable of storing both (i) program instructions that are executable by the processor of on-board computing system 502 such that on-board computing system 502 is configured to perform various functions related to the autonomous operation of vehicle 500 (among other possible functions), and (ii) data that may be obtained, derived, or otherwise stored by on-board computing system 502.

In one embodiment, on-board computing system 502 may also be functionally configured into a number of different subsystems that are each tasked with performing a specific subset of functions that facilitate the autonomous operation of vehicle 500, and these subsystems may be collectively referred to as the vehicle's “autonomy system.” In practice, each of these subsystems may be implemented in the form of program instructions that are stored in the on-board computing system's data storage and are executable by the on-board computing system's processor to carry out the subsystem's specific subset of functions, although other implementations are possible as well—including the possibility that different subsystems could be implemented via different hardware components of on-board computing system 502.

As shown in FIG. 5, in one embodiment, the functional subsystems of on-board computing system 502 may include (i) a perception subsystem 502a that generally functions to derive a representation of the surrounding environment being perceived by vehicle 500, (ii) a prediction subsystem 502b that generally functions to predict the future state of each object detected in the vehicle's surrounding environment, (iii) a planning subsystem 502c that generally functions to derive a behavior plan for vehicle 500, (iv) a control subsystem 502d that generally functions to transform the behavior plan for vehicle 500 into control signals for causing vehicle 500 to execute the behavior plan, and (v) a vehicle-interface subsystem 502e that generally functions to translate the control signals into a format that vehicle-control system 503 can interpret and execute. However, it should be understood that the functional subsystems of on-board computing system 502 may take various other forms as well. Each of these example subsystems will now be described in further detail below.

For instance, the subsystems of on-board computing system 502 may begin with perception subsystem 502a, which may be configured to fuse together various different types of “raw” data that relate to the vehicle's perception of its surrounding environment and thereby derive a representation of the surrounding environment being perceived by vehicle 500. In this respect, the “raw” data that is used by perception subsystem 502a to derive the representation of the vehicle's surrounding environment may take any of various forms.

For instance, at a minimum, the “raw” data that is used by perception subsystem 502a may include multiple different types of sensor data captured by sensor system 501, such as 2D sensor data (e.g., image data) that provides a 2D representation of the vehicle's surrounding environment, 3D sensor data (e.g., LiDAR data) that provides a 3D representation of the vehicle's surrounding environment, and/or state data for vehicle 500 that indicates the past and current position, orientation, velocity, and acceleration of vehicle 500. Additionally, the “raw” data that is used by perception subsystem 502a may include map data associated with the vehicle's location, such as high-definition geometric and/or semantic map data, which may be preloaded onto on-board computing system 502 and/or obtained from a remote computing system. Additionally yet, the “raw” data that is used by perception subsystem 502a may include navigation data for vehicle 500 that indicates a specified origin and/or specified destination for vehicle 500, which may be obtained from a remote computing system (e.g., a transportation-matching system) and/or input by a human riding in vehicle 500 via a user-interface component that is communicatively coupled to on-board computing system 502. Additionally still, the “raw” data that is used by perception subsystem 502a may include other types of data that may provide context for the vehicle's perception of its surrounding environment, such as weather data and/or traffic data, which may be obtained from a remote computing system. The “raw” data that is used by perception subsystem 502a may include other types of data as well.

Advantageously, by fusing together multiple different types of raw data (e.g., both 2D sensor data and 3D sensor data), perception subsystem 502a is able to leverage the relative strengths of these different types of raw data in a way that may produce a more accurate and precise representation of the surrounding environment being perceived by vehicle 500.

Further, the function of deriving the representation of the surrounding environment perceived by vehicle 500 using the raw data may include various aspects. For instance, one aspect of deriving the representation of the surrounding environment perceived by vehicle 500 using the raw data may involve determining a current state of vehicle 500 itself, such as a current position, a current orientation, a current velocity, and/or a current acceleration, among other possibilities. In this respect, perception subsystem 502a may also employ a localization technique such as SLAM to assist in the determination of the vehicle's current position and/or orientation. (Alternatively, it is possible that on-board computing system 502 may run a separate localization service that determines position and/or orientation values for vehicle 500 based on raw data, in which case these position and/or orientation values may serve as another input to perception subsystem 502a).

Another aspect of deriving the representation of the surrounding environment perceived by vehicle 500 using the raw data may involve detecting objects within the vehicle's surrounding environment, which may result in the determination of class labels, bounding boxes, or the like for each detected object. In this respect, the particular classes of objects that are detected by perception subsystem 502a (which may be referred to as “agents”) may take various forms, including both (i) “dynamic” objects that have the potential to move, such as vehicles, cyclists, pedestrians, and animals, among other examples, and (ii) “static” objects that generally do not have the potential to move, such as streets, curbs, lane markings, traffic lights, stop signs, and buildings, among other examples. Further, in practice, perception subsystem 502a may be configured to detect objects within the vehicle's surrounding environment using any type of object detection model now known or later developed, including but not limited object detection models based on convolutional neural networks (CNN).

Yet another aspect of deriving the representation of the surrounding environment perceived by vehicle 500 using the raw data may involve determining a current state of each object detected in the vehicle's surrounding environment, such as a current position (which could be reflected in terms of coordinates and/or in terms of a distance and direction from vehicle 500), a current orientation, a current velocity, and/or a current acceleration of each detected object, among other possibilities. In this respect, the current state of each detected object may be determined either in terms of an absolute measurement system or in terms of a relative measurement system that is defined relative to a state of vehicle 500, among other possibilities.

The function of deriving the representation of the surrounding environment perceived by vehicle 500 using the raw data may include other aspects as well.

Further yet, the derived representation of the surrounding environment perceived by vehicle 500 may incorporate various different information about the surrounding environment perceived by vehicle 500, examples of which may include (i) a respective set of information for each object detected in the vehicle's surrounding, such as a class label, a bounding box, and/or state information for each detected object, (ii) a set of information for vehicle 500 itself, such as state information and/or navigation information (e.g., a specified destination), and/or (iii) other semantic information about the surrounding environment (e.g., time of day, weather conditions, traffic conditions, etc.). The derived representation of the surrounding environment perceived by vehicle 500 may incorporate other types of information about the surrounding environment perceived by vehicle 500 as well.

Still further, the derived representation of the surrounding environment perceived by vehicle 500 may be embodied in various forms. For instance, as one possibility, the derived representation of the surrounding environment perceived by vehicle 500 may be embodied in the form of a data structure that represents the surrounding environment perceived by vehicle 500, which may comprise respective data arrays (e.g., vectors) that contain information about the objects detected in the surrounding environment perceived by vehicle 500, a data array that contains information about vehicle 500, and/or one or more data arrays that contain other semantic information about the surrounding environment. Such a data structure may be referred to as a “parameter-based encoding.”

As another possibility, the derived representation of the surrounding environment perceived by vehicle 500 may be embodied in the form of a rasterized image that represents the surrounding environment perceived by vehicle 500 in the form of colored pixels. In this respect, the rasterized image may represent the surrounding environment perceived by vehicle 500 from various different visual perspectives, examples of which may include a “top down” view and a “bird's eye” view of the surrounding environment, among other possibilities. Further, in the rasterized image, the objects detected in the surrounding environment of vehicle 500 (and perhaps vehicle 500 itself) could be shown as color-coded bitmasks and/or bounding boxes, among other possibilities.

The derived representation of the surrounding environment perceived by vehicle 500 may be embodied in other forms as well.

As shown, perception subsystem 502a may pass its derived representation of the vehicle's surrounding environment to prediction subsystem 502b. In turn, prediction subsystem 502b may be configured to use the derived representation of the vehicle's surrounding environment (and perhaps other data) to predict a future state of each object detected in the vehicle's surrounding environment at one or more future times (e.g., at each second over the next 5 seconds) —which may enable vehicle 500 to anticipate how the real-world objects in its surrounding environment are likely to behave in the future and then plan its behavior in a way that accounts for this future behavior.

Prediction subsystem 502b may be configured to predict various aspects of a detected object's future state, examples of which may include a predicted future position of the detected object, a predicted future orientation of the detected object, a predicted future velocity of the detected object, and/or predicted future acceleration of the detected object, among other possibilities. In this respect, if prediction subsystem 502b is configured to predict this type of future state information for a detected object at multiple future times, such a time sequence of future states may collectively define a predicted future trajectory of the detected object. Further, in some embodiments, prediction subsystem 502b could be configured to predict multiple different possibilities of future states for a detected object (e.g., by predicting the 3 most-likely future trajectories of the detected object). Prediction subsystem 502b may be configured to predict other aspects of a detected object's future behavior as well.

In practice, prediction subsystem 502b may predict a future state of an object detected in the vehicle's surrounding environment in various manners, which may depend in part on the type of detected object. For instance, as one possibility, prediction subsystem 502b may predict the future state of a detected object using a data science model that is configured to (i) receive input data that includes one or more derived representations output by perception subsystem 502a at one or more perception times (e.g., the “current” perception time and perhaps also one or more prior perception times), (ii) based on an evaluation of the input data, which includes state information for the objects detected in the vehicle's surrounding environment at the one or more perception times, predict at least one likely time sequence of future states of the detected object (e.g., at least one likely future trajectory of the detected object), and (iii) output an indicator of the at least one likely time sequence of future states of the detected object. This type of data science model may be referred to herein as a “future-state model.”

Such a future-state model will typically be created by an off-board computing system (e.g., a backend platform) and then loaded onto on-board computing system 502, although it is possible that a future-state model could be created by on-board computing system 502 itself. Either way, the future-state model may be created using any modeling technique now known or later developed, including but not limited to a machine-learning technique that may be used to iteratively “train” the data science model to predict a likely time sequence of future states of an object based on training data. The training data may comprise both test data (e.g., historical representations of surrounding environments at certain historical perception times) and associated ground-truth data (e.g., historical state data that indicates the actual states of objects in the surrounding environments during some window of time following the historical perception times).

Prediction subsystem 502b could predict the future state of a detected object in other manners as well. For instance, for detected objects that have been classified by perception subsystem 502a as belonging to certain classes of static objects (e.g., roads, curbs, lane markings, etc.), which generally do not have the potential to move, prediction subsystem 502b may rely on this classification as a basis for predicting that the future state of the detected object will remain the same at each of the one or more future times (in which case the state-prediction model may not be used for such detected objects). However, it should be understood that detected objects may be classified by perception subsystem 502a as belonging to other classes of static objects that have the potential to change state despite not having the potential to move, in which case prediction subsystem 502b may still use a future-state model to predict the future state of such detected objects. One example of a static object class that falls within this category is a traffic light, which generally does not have the potential to move but may nevertheless have the potential to change states (e.g. between green, yellow, and red) while being perceived by vehicle 500.

After predicting the future state of each object detected in the surrounding environment perceived by vehicle 500 at one or more future times, prediction subsystem 502b may then either incorporate this predicted state information into the previously-derived representation of the vehicle's surrounding environment (e.g., by adding data arrays to the data structure that represents the surrounding environment) or derive a separate representation of the vehicle's surrounding environment that incorporates the predicted state information for the detected objects, among other possibilities.

As shown, prediction subsystem 502b may pass the one or more derived representations of the vehicle's surrounding environment to planning subsystem 502c. In turn, planning subsystem 502c may be configured to use the one or more derived representations of the vehicle's surrounding environment (and perhaps other data) to derive a behavior plan for vehicle 500, which defines the desired driving behavior of vehicle 500 for some future period of time (e.g., the next 5 seconds).

The behavior plan that is derived for vehicle 500 may take various forms. For instance, as one possibility, the derived behavior plan for vehicle 500 may comprise a planned trajectory for vehicle 500 that specifies a planned state of vehicle 500 at each of one or more future times (e.g., each second over the next 5 seconds), where the planned state for each future time may include a planned position of vehicle 500 at the future time, a planned orientation of vehicle 500 at the future time, a planned velocity of vehicle 500 at the future time, and/or a planned acceleration of vehicle 500 (whether positive or negative) at the future time, among other possible types of state information. As another possibility, the derived behavior plan for vehicle 500 may comprise one or more planned actions that are to be performed by vehicle 500 during the future window of time, where each planned action is defined in terms of the type of action to be performed by vehicle 500 and a time and/or location at which vehicle 500 is to perform the action, among other possibilities. The derived behavior plan for vehicle 500 may define other planned aspects of the vehicle's behavior as well.

Further, in practice, planning subsystem 502c may derive the behavior plan for vehicle 500 in various manners. For instance, as one possibility, planning subsystem 502c may be configured to derive the behavior plan for vehicle 500 by (i) deriving a plurality of different “candidate” behavior plans for vehicle 500 based on the one or more derived representations of the vehicle's surrounding environment (and perhaps other data), (ii) evaluating the candidate behavior plans relative to one another (e.g., by scoring the candidate behavior plans using one or more cost functions) in order to identify which candidate behavior plan is most desirable when considering factors such as proximity to other objects, velocity, acceleration, time and/or distance to destination, road conditions, weather conditions, traffic conditions, and/or traffic laws, among other possibilities, and then (iii) selecting the candidate behavior plan identified as being most desirable as the behavior plan to use for vehicle 500. Planning subsystem 502c may derive the behavior plan for vehicle 500 in various other manners as well.

After deriving the behavior plan for vehicle 500, planning subsystem 502c may pass data indicating the derived behavior plan to control subsystem 502d. In turn, control subsystem 502d may be configured to transform the behavior plan for vehicle 500 into one or more control signals (e.g., a set of one or more command messages) for causing vehicle 500 to execute the behavior plan. For instance, based on the behavior plan for vehicle 500, control subsystem 502d may be configured to generate control signals for causing vehicle 500 to adjust its steering in a specified manner, accelerate in a specified manner, and/or brake in a specified manner, among other possibilities.

As shown, control subsystem 502d may then pass the one or more control signals for causing vehicle 500 to execute the behavior plan to vehicle-interface subsystem 502e. In turn, vehicle-interface subsystem 502e may be configured to translate the one or more control signals into a format that can be interpreted and executed by components of vehicle-control system 503. For example, vehicle-interface subsystem 502e may be configured to translate the one or more control signals into one or more control messages are defined according to a particular format or standard, such as a CAN bus standard and/or some other format or standard that is used by components of vehicle-control system 503.

In turn, vehicle-interface subsystem 502e may be configured to direct the one or more control signals to the appropriate control components of vehicle-control system 503. For instance, as shown, vehicle-control system 503 may include a plurality of actuators that are each configured to control a respective aspect of the vehicle's physical operation, such as a steering actuator 503a that is configured to control the vehicle components responsible for steering (not shown), an acceleration actuator 503b that is configured to control the vehicle components responsible for acceleration such as a throttle (not shown), and a braking actuator 503c that is configured to control the vehicle components responsible for braking (not shown), among other possibilities. In such an arrangement, vehicle-interface subsystem 502e of on-board computing system 502 may be configured to direct steering-related control signals to steering actuator 503a, acceleration-related control signals to acceleration actuator 503b, and braking-related control signals to braking actuator 503c. However, it should be understood that the control components of vehicle-control system 503 may take various other forms as well.

Notably, the subsystems of on-board computing system 502 may be configured to perform the above functions in a repeated manner, such as many times per second, which may enable vehicle 500 to continually update both its understanding of the surrounding environment and its planned behavior within that surrounding environment.

Although not specifically shown, it should be understood that vehicle 500 includes various other systems and components as well, including but not limited to a propulsion system that is responsible for creating the force that leads to the physical movement of vehicle 500.

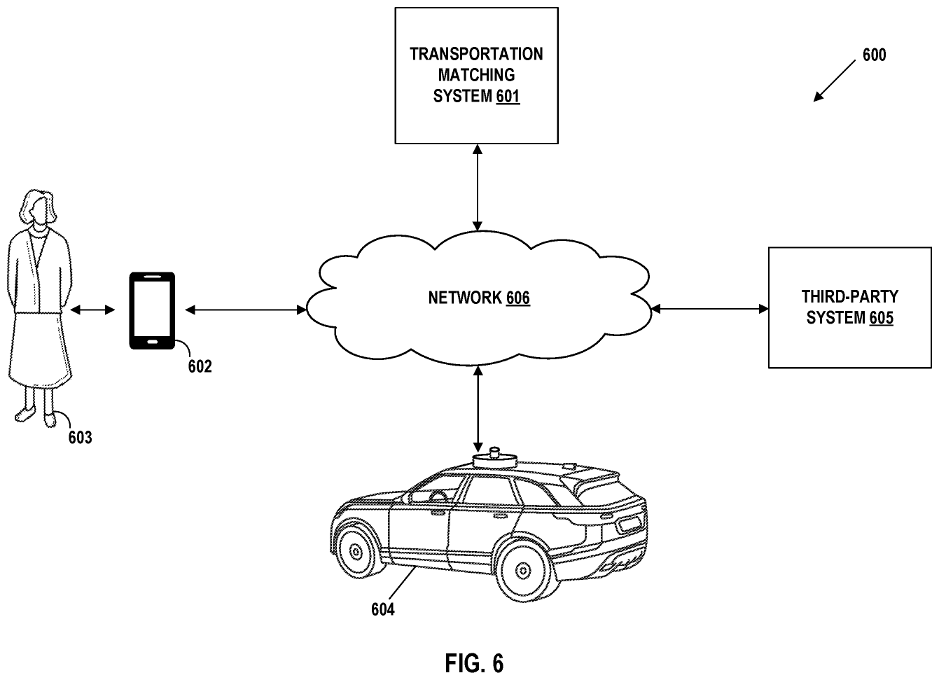

Turning now to FIG. 6, a simplified block diagram is provided to illustrate one example of a transportation-matching platform 600 that functions to match individuals interested in obtaining transportation from one location to another with transportation options, such as vehicles that are capable of providing the requested transportation. As shown, transportation-matching platform 600 may include at its core a transportation-matching system 601, which may be communicatively coupled via a communication network 606 to (i) a plurality of client stations of individuals interested in transportation (i.e., “transportation requestors”), of which client station 602 of transportation requestor 603 is shown as one representative example, (ii) a plurality of vehicles that are capable of providing the requested transportation, of which vehicle 604 is shown as one representative example, and (iii) a plurality of third-party systems that are capable of providing respective subservices that facilitate the platform's transportation matching, of which third-party system 605 is shown as one representative example.

Broadly speaking, transportation-matching system 601 may include one or more computing systems that collectively comprise a communication interface, at least one processor, data storage, and executable program instructions for carrying out functions related to managing and facilitating transportation matching. These one or more computing systems may take various forms and be arranged in various manners. For instance, as one possibility, transportation-matching system 601 may comprise computing infrastructure of a public, private, and/or hybrid cloud (e.g., computing and/or storage clusters). In this respect, the entity that owns and operates transportation-matching system 601 may either supply its own cloud infrastructure or may obtain the cloud infrastructure from a third-party provider of “on demand” computing resources, such as Amazon Web Services (AWS), Microsoft Azure, Google Cloud, Alibaba Cloud, or the like. As another possibility, transportation-matching system 601 may comprise one or more dedicated servers. Other implementations of transportation-matching system 601 are possible as well.

As noted, transportation-matching system 601 may be configured to perform functions related to managing and facilitating transportation matching, which may take various forms. For instance, as one possibility, transportation-matching system 601 may be configured to receive transportation requests from client stations of transportation requestors (e.g., client station 602 of transportation requestor 603) and then fulfill such transportation requests by dispatching suitable vehicles, which may include vehicle 604. In this respect, a transportation request from client station 602 of transportation requestor 603 may include various types of information.

For example, a transportation request from client station 602 of transportation requestor 603 may include specified pick-up and drop-off locations for the transportation. As another example, a transportation request from client station 602 of transportation requestor 603 may include an identifier that identifies transportation requestor 603 in transportation-matching system 601, which may be used by transportation-matching system 601 to access information about transportation requestor 603 (e.g., profile information) that is stored in one or more data stores of transportation-matching system 601 (e.g., a relational database system), in accordance with the transportation requestor's privacy settings. This transportation requestor information may take various forms, examples of which include profile information about transportation requestor 603. As yet another example, a transportation request from client station 602 of transportation requestor 603 may include preferences information for transportation requestor 603, examples of which may include vehicle-operation preferences (e.g., safety comfort level, preferred speed, rates of acceleration or deceleration, safety distance from other vehicles when traveling at various speeds, route, etc.), entertainment preferences (e.g., preferred music genre or playlist, audio volume, display brightness, etc.), temperature preferences, and/or any other suitable information.

As another possibility, transportation-matching system 601 may be configured to access information related to a requested transportation, examples of which may include information about locations related to the transportation, traffic data, route options, optimal pick-up or drop-off locations for the transportation, and/or any other suitable information associated with requested transportation. As an example and not by way of limitation, when transportation-matching system 601 receives a request for transportation from San Francisco International Airport (SFO) to Palo Alto, Calif., system 601 may access or generate any relevant information for this particular transportation request, which may include preferred pick-up locations at SFO, alternate pick-up locations in the event that a pick-up location is incompatible with the transportation requestor (e.g., the transportation requestor may be disabled and cannot access the pick-up location) or the pick-up location is otherwise unavailable due to construction, traffic congestion, changes in pick-up/drop-off rules, or any other reason, one or more routes to travel from SFO to Palo Alto, preferred off-ramps for a type of transportation requestor, and/or any other suitable information associated with the transportation.

In some embodiments, portions of the accessed information could also be based on historical data associated with historical transportation facilitated by transportation-matching system 601. For example, historical data may include aggregate information generated based on past transportation information, which may include any information described herein and/or other data collected by sensors affixed to or otherwise located within vehicles (including sensors of other computing devices that are located in the vehicles such as client stations). Such historical data may be associated with a particular transportation requestor (e.g., the particular transportation requestor's preferences, common routes, etc.), a category/class of transportation requestors (e.g., based on demographics), and/or all transportation requestors of transportation-matching system 601.

For example, historical data specific to a single transportation requestor may include information about past rides that a particular transportation requestor has taken, including the locations at which the transportation requestor is picked up and dropped off, music the transportation requestor likes to listen to, traffic information associated with the rides, time of day the transportation requestor most often rides, and any other suitable information specific to the transportation requestor. As another example, historical data associated with a category/class of transportation requestors may include common or popular ride preferences of transportation requestors in that category/class, such as teenagers preferring pop music, transportation requestors who frequently commute to the financial district may prefer to listen to the news, etc. As yet another example, historical data associated with all transportation requestors may include general usage trends, such as traffic and ride patterns.

Using such historical data, transportation-matching system 601 could be configured to predict and provide transportation suggestions in response to a transportation request. For instance, transportation-matching system 601 may be configured to apply one or more machine-learning techniques to such historical data in order to “train” a machine-learning model to predict transportation suggestions for a transportation request. In this respect, the one or more machine-learning techniques used to train such a machine-learning model may take any of various forms, examples of which may include a regression technique, a neural-network technique, a k-Nearest Neighbor (kNN) technique, a decision-tree technique, a support-vector-machines (SVM) technique, a Bayesian technique, an ensemble technique, a clustering technique, an association-rule-learning technique, and/or a dimensionality-reduction technique, among other possibilities.

In operation, transportation-matching system 601 may only be capable of storing and later accessing historical data for a given transportation requestor if the given transportation requestor previously decided to “opt-in” to having such information stored. In this respect, transportation-matching system 601 may maintain respective privacy settings for each transportation requestor that uses transportation-matching platform 600 and operate in accordance with these settings. For instance, if a given transportation requestor did not opt-in to having his or her information stored, then transportation-matching system 601 may forgo performing any of the above-mentioned functions based on historical data. Other possibilities also exist.

Transportation-matching system 601 may be configured to perform various other functions related to managing and facilitating transportation matching as well.

Referring again to FIG. 6, client station 602 of transportation requestor 603 may generally comprise any computing device that is configured to facilitate interaction between transportation requestor 603 and transportation-matching system 601. For instance, client station 602 may take the form of a smartphone, a tablet, a desktop computer, a laptop, a netbook, and/or a PDA, among other possibilities. Each such device may comprise an I/O interface, a communication interface, a GNSS unit such as a GPS unit, at least one processor, data storage, and executable program instructions for facilitating interaction between transportation requestor 603 and transportation-matching system 601 (which may be embodied in the form of a software application, such as a mobile application, web application, or the like). In this respect, the interaction that may take place between transportation requestor 603 and transportation-matching system 601 may take various forms, representative examples of which may include requests by transportation requestor 603 for new transportation events, confirmations by transportation-matching system 601 that transportation requestor 603 has been matched with a vehicle (e.g., vehicle 604), and updates by transportation-matching system 601 regarding the progress of the transportation event, among other possibilities.

In turn, vehicle 604 may generally comprise any kind of vehicle that can provide transportation, and in one example, may take the form of vehicle 500 described above. Further, the functionality carried out by vehicle 604 as part of transportation-matching platform 600 may take various forms, representative examples of which may include receiving a request from transportation-matching system 601 to handle a new transportation event, driving to a specified pickup location for a transportation event, driving from a specified pickup location to a specified drop-off location for a transportation event, and providing updates regarding the progress of a transportation event to transportation-matching system 601, among other possibilities.

Generally speaking, third-party system 605 may include one or more computing systems that collectively comprise a communication interface, at least one processor, data storage, and executable program instructions for carrying out functions related to a third-party subservice that facilitates the platform's transportation matching. These one or more computing systems may take various forms and may be arranged in various manners, such as any one of the forms and/or arrangements discussed above with reference to transportation-matching system 601.

Moreover, third-party system 605 may be configured to perform functions related to various subservices. For instance, as one possibility, third-party system 605 may be configured to monitor traffic conditions and provide traffic data to transportation-matching system 601 and/or vehicle 604, which may be used for a variety of purposes. For example, transportation-matching system 601 may use such data to facilitate fulfilling transportation requests in the first instance and/or updating the progress of initiated transportation events, and vehicle 604 may use such data to facilitate updating certain predictions regarding perceived agents and/or the vehicle's behavior plan, among other possibilities.

As another possibility, third-party system 605 may be configured to monitor weather conditions and provide weather data to transportation-matching system 601 and/or vehicle 604, which may be used for a variety of purposes. For example, transportation-matching system 601 may use such data to facilitate fulfilling transportation requests in the first instance and/or updating the progress of initiated transportation events, and vehicle 604 may use such data to facilitate updating certain predictions regarding perceived agents and/or the collection vehicle's behavior plan, among other possibilities.

As yet another possibility, third-party system 605 may be configured to authorize and process electronic payments for transportation requests. For example, after transportation requestor 603 submits a request for a new transportation event via client station 602, third-party system 605 may be configured to confirm that an electronic payment method for transportation requestor 603 is valid and authorized and then inform transportation-matching system 601 of this confirmation, which may cause transportation-matching system 601 to dispatch vehicle 604 to pick up transportation requestor 603. After receiving a notification that the transportation event is complete, third-party system 605 may then charge the authorized electronic payment method for transportation requestor 603 according to the fare for the transportation event. Other possibilities also exist.

Third-party system 605 may be configured to perform various other functions related to sub services that facilitate the platform's transportation matching as well. It should be understood that, although certain functions were discussed as being performed by third-party system 605, some or all of these functions may instead be performed by transportation-matching system 601.

As discussed above, transportation-matching system 601 may be communicatively coupled to client station 602, vehicle 604, and third-party system 605 via communication network 606, which may take various forms. For instance, at a high level, communication network 606 may include one or more Wide-Area Networks (WANs) (e.g., the Internet or a cellular network), Local-Area Networks (LANs), and/or Personal Area Networks (PANs), among other possibilities, where each such network may be wired and/or wireless and may carry data according to any of various different communication protocols. Further, it should be understood that the respective communication paths between the various entities of FIG. 6 may take other forms as well, including the possibility that such communication paths include communication links and/or intermediate devices that are not shown.

In the foregoing arrangement, client station 602, vehicle 604, and/or third-party system 605 may also be capable of indirectly communicating with one another via transportation-matching system 601. Additionally, although not shown, it is possible that client station 602, vehicle 604, and/or third-party system 605 may be configured to communicate directly with one another as well (e.g., via a short-range wireless communication path or the like). Further, vehicle 604 may also include a user-interface system that may facilitate direct interaction between transportation requestor 603 and vehicle 604 once transportation requestor 603 enters vehicle 604 and the transportation event begins.

It should be understood that transportation-matching platform 600 may include various other entities and take various other forms as well.

Turning now to FIG. 7, a simplified block diagram is provided to illustrate some structural components that may be included in an example computing platform 700, which may be configured to carry out the any of various functions disclosed herein—including but not limited to the functions included in the example pipeline described with reference to FIGS. 3 and 4A-4H. At a high level, computing platform 700 may generally comprise any one or more computer systems (e.g., one or more servers) that collectively include at least a processor 702, data storage 704, and a communication interface 706, all of which may be communicatively linked by a communication link 708 that may take the form of a system bus, a communication network such as a public, private, or hybrid cloud, or some other connection mechanism. Each of these components may take various forms.

For instance, processor 702 may comprise one or more processor components, such as general-purpose processors (e.g., a single- or multi-core microprocessor), special-purpose processors (e.g., an application-specific integrated circuit or digital-signal processor), programmable logic devices (e.g., a field programmable gate array), controllers (e.g., microcontrollers), and/or any other processor components now known or later developed. In line with the discussion above, it should also be understood that processor 702 could comprise processing components that are distributed across a plurality of physical computing devices connected via a network, such as a computing cluster of a public, private, or hybrid cloud.

In turn, data storage 704 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that data storage 704 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 7, data storage 704 may be capable of storing both (i) program instructions that are executable by processor 702 such that the computing platform 700 is configured to perform any of the various functions disclosed herein (including but not limited to any the functions described with reference to FIGS. 3 and 4A-4H), and (ii) data that may be received, derived, or otherwise stored by computing platform 700. For instance, data storage 704 may include one or more of the vehicle trajectory information 307, agent trajectory information 308, non-agent information 309, and/or dynamic scene representations 311 shown in FIG. 3, among other possibilities.

Communication interface 706 may take the form of any one or more interfaces that facilitate communication between computing platform 700 and other systems or devices. In this respect, each such interface may be wired and/or wireless and may communicate according to any of various communication protocols, examples of which may include Ethernet, Wi-Fi, Controller Area Network (CAN) bus, serial bus (e.g., Universal Serial Bus (USB) or Firewire), cellular network, and/or short-range wireless protocols, among other possibilities.

Although not shown, computing platform 700 may additionally include one or more input/output (I/O) interfaces that are configured to either (i) receive and/or capture information at computing platform 700 and (ii) output information to a client station (e.g., for presentation to a user). In this respect, the one or more I/O interfaces may include or provide connectivity to input components such as a microphone, a camera, a keyboard, a mouse, a trackpad, a touchscreen, and/or a stylus, among other possibilities, as well as output components such as a display screen and/or an audio speaker, among other possibilities.

It should be understood that computing platform 700 is one example of a computing platform that may be used with the embodiments described herein. Numerous other arrangements are possible and contemplated herein. For instance, other computing platforms may include additional components not pictured and/or more or less of the pictured components.

### CONCLUSION

This disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners without departing from the true scope and spirit of the present invention, which will be defined by the claims.

Further, to the extent that examples described herein involve operations performed or initiated by actors, such as “humans,” “curators,” “users” or other entities, this is for purposes of example and explanation only. The claims should not be construed as requiring action by such actors unless explicitly recited in the claim language.

We claim:

1. A computer-implemented method comprising:
receiving sensor data associated with a period of operation in an environment by at least one sensor of a vehicle, wherein the sensor data includes (i) trajectory data associated with the vehicle during the period of operation, and (ii) at least one of trajectory data associated with one or more agents in the environment during the period of operation or data associated with one or more static objects in the environment during the period of operation;
determining, at each of a series of times during the period of operation, that at least one of (i) the one or more agents or (ii) the one or more static objects is relevant to the vehicle, wherein determining that at least one of (i) the one or more agents or (ii) the one or more static objects is relevant to the vehicle is based on a likelihood that at least one of (i) the one or more agents or (ii) the one or more static objects is predicted to affect a planned future trajectory of the vehicle;
identifying, from the series of times, one or more times during the period of operation when there is a change to at least one of (i) the one or more agents or (ii) the one or more static objects determined to be relevant to the vehicle;
designating each of the one or more identified times as a boundary point that separates the period of operation into one or more scenes; and
generating a representation of the one or more scenes based on the designated boundary points, wherein each of the one or more scenes includes (i) a portion of the trajectory data associated with the vehicle, and (ii) at least one of a portion of the trajectory data associated with the one or more agents or a portion of the data associated with the one or more static objects.

2. The computer-implemented method of claim 1, wherein generating a representation of the one or more scenes comprises:
generating a respective representation of each of the one or more scenes that includes (i) the trajectory data for the vehicle during the scene and (ii) one or both of (a) trajectory data for at least one agent that is determined to be relevant to the planned future trajectory of the vehicle during the scene, or (b) data associated with at least one static object that is determined to be relevant to the planned future trajectory of the vehicle during the scene.

3. The computer-implemented method of claim 2, wherein one or both of (i) the trajectory data for the vehicle during the scene or (ii) the trajectory data for the at least one agent that is determined to be relevant to the planned future trajectory of the vehicle during the scene comprises confidence information indicating an estimated accuracy of the trajectory data.

4. The computer-implemented method of claim 1, wherein identifying, from the series of times, one or more times during the period of operation when there is a change to at least one of (i) the one or more agents or (ii) the one or more static objects determined to be relevant to the vehicle comprises:
determining that at least one of the one or more agents that was determined to be relevant to the vehicle is no longer relevant to the vehicle.

5. The computer-implemented method of claim 1, further comprising:
based on the received sensor data, deriving past trajectory data for (i) the vehicle and (ii) the one or more agents in the environment during the period of operation; and
based on the received sensor data, generating future trajectory data for (i) the vehicle and (ii) the one or more agents in the environment during the period of operation.

6. The computer implemented method of claim 1, wherein determining that at least one of (i) the one or more agents or (ii) the one or more static objects is relevant to the vehicle comprises predicting at least one of: (a) a likelihood that the planned future trajectory of the vehicle will intersect a predicted trajectory for the one or more agents, or (b) a likelihood that at least one of (i) the one or more agents or (ii) the one or more static objects will be located within a predetermined zone of proximity to the vehicle.

7. The computer-implemented method of claim 1, further comprising:
based on a selected scene included in the one or more scenes, predicting one or more alternative versions of the selected scene.

8. The computer-implemented method of claim 7, wherein predicting one or more alternative versions of the selected scene comprises:
generating, for the selected scene, one or more alternative versions of one or both of (i) the trajectory data for the vehicle during the scene or (ii) the trajectory data for at least one agent in the environment during the scene.

9. The computer-implemented method of claim 1, further comprising:
based on (i) a first scene included in the one or more scenes and (ii) a second scene included in the one or more scenes, generating a representation of a new scene comprising:
at least one of (i) trajectory data for the vehicle during the first scene or (ii) trajectory data for at least one agent in the environment during the first scene; and
at least one of (i) trajectory data for the vehicle during the second scene or (ii) trajectory data for at least one agent in the environment during the second scene.

10. The computer-implemented method of claim 1, wherein determining that at least one of (i) the one or more agents or (ii) the one or more static objects is relevant to the vehicle comprises determining that a probability that at least one of (i) the one or more agents or (ii) the one or more static objects will affect the planned future trajectory of the vehicle during a future time horizon exceeds a predetermined threshold probability.

11. A non-transitory computer-readable medium comprising program instructions stored thereon that are executable to cause a computing system to:
receive sensor data associated with a period of operation in an environment by at least one sensor of a vehicle, wherein the sensor data includes (i) trajectory data associated with the vehicle during the period of operation, and (ii) at least one of trajectory data associated with one or more agents in the environment during the period of operation or data associated with one or more static objects in the environment during the period of operation;
determine, at each of a series of times during the period of operation, that at least one of (i) the one or more agents or (ii) the one or more static objects is relevant to the vehicle, wherein determining that at least one of (i) the one or more agents or (ii) the one or more static objects is relevant to the vehicle is based on a likelihood that at least one of (i) the one or more agents or (ii) the one or more static objects is predicted to affect a planned future trajectory of the vehicle;
identify, from the series of times, one or more times during the period of operation when there is a change to at least one of (i) the one or more agents or (ii) the one or more static objects determined to be relevant to the vehicle;
designate each of the one or more identified times as a boundary point that separates the period of operation into one or more scenes; and
generate a representation of the one or more scenes based on the designated boundary points, wherein each of the one or more scenes includes (i) a portion of the trajectory data associated with the vehicle, and (ii) at least one of a portion of the trajectory data associated with the one or more agents or a portion of the data associated with the one or more static objects.

12. The computer-readable medium of claim 11, wherein generating a representation of the one or more scenes comprises:
generating a respective representation of each of the one or more scenes that includes (i) the trajectory data for the vehicle during the scene and (ii) one or both of (a) trajectory data for at least one agent that is determined to be relevant to the planned future trajectory of the vehicle during the scene, or (b) data associated with at least one static object that is determined to be relevant to the planned future trajectory of the vehicle during the scene.

13. The computer-readable medium of claim 12, wherein one or both of (i) the trajectory data for the vehicle during the scene or (ii) the trajectory data for the at least one agent that is determined to be relevant to the planned future trajectory of the vehicle during the scene comprises confidence information indicating an estimated accuracy of the trajectory data.

14. The computer-readable medium of claim 11, wherein identifying, from the series of times, one or more times during the period of operation when there is a change to at least one of (i) the one or more agents or (ii) the one or more static objects determined to be relevant to the vehicle comprises:
determining that at least one of the one or more agents that was determined to be relevant to the vehicle is no longer relevant to the vehicle.

15. The computer-readable medium of claim 11, wherein the computer-readable medium further comprises program instructions stored thereon that are executable to cause the computing system to:
based on the received sensor data, deriving past trajectory data for (i) the vehicle and (ii) the one or more agents in the environment during the period of operation; and
based on the received sensor data, generating future trajectory data for (i) the vehicle and (ii) the one or more agents in the environment during the period of operation.

16. The computer-readable medium of claim 11, wherein determining that at least one of (i) the one or more agents or (ii) the one or more static objects is relevant to the vehicle comprises predicting at least one of: (a) a likelihood that the planned future trajectory of the vehicle will intersect a predicted trajectory for the one or more agents, or (b) a likelihood that at least one of (i) the one or more agents or (ii) the one or more static objects will be located within a predetermined zone of proximity to the vehicle.

17. The computer-readable medium of claim 11, wherein the computer-readable medium further comprises program instructions stored thereon that are executable to cause the computing system to:
based on a selected scene included in the one or more scenes, predicting one or more alternative versions of the selected scene.

18. The computer-readable medium of claim 17, wherein predicting one or more alternative versions of the selected scene comprises:
generating, for the selected scene, one or more alternative versions of one or both of (i) the trajectory data for the vehicle during the scene or (ii) the trajectory data for at least one agent in the environment during the scene.

19. The computer-readable medium of claim 11, wherein the computer-readable medium further comprises program instructions stored thereon that are executable to cause the computing system to:
based on (i) a first scene included in the one or more scenes and (ii) a second scene included in the one or more scenes, generating a representation of a new scene comprising:
at least one of (i) trajectory data for the vehicle during the first scene or (ii) trajectory data for at least one agent in the environment during the first scene; and
at least one of (i) trajectory data for the vehicle during the second scene or (ii) trajectory data for at least one agent in the environment during the second scene.

20. A computing system comprising:
at least one processor;
a non-transitory computer-readable medium; and
program instructions stored on the non-transitory computer-readable medium that are executable by the at least one processor such that the computing system is capable of:
receiving sensor data associated with a period of operation in an environment by at least one sensor of a vehicle, wherein the sensor data includes (i) trajectory data associated with the vehicle during the period of operation, and (ii) at least one of trajectory data associated with one or more agents in the environment during the period of operation or data associated with one or more static objects in the environment during the period of operation;
determining, at each of a series of times during the period of operation, that at least one of (i) the one or more agents or (ii) the one or more static objects is relevant to the vehicle, wherein determining that at least one of (i) the one or more agents or (ii) the one or more static objects is relevant to the vehicle is based on a likelihood that at least one of (i) the one or more agents or (ii) the one or more static objects is predicted to affect a planned future trajectory of the vehicle;
identifying, from the series of times, one or more times during the period of operation when there is a change to at least one of (i) the one or more agents or (ii) the one or more static objects determined to be relevant to the vehicle;
designating each of the one or more identified times as a boundary point that separates the period of operation into one or more scenes; and
generating a representation of the one or more scenes based on the designated boundary points, wherein each of the one or more scenes includes (i) a portion of the trajectory data associated with the vehicle, and (ii) at least one of a portion of the trajectory data associated with the one or more agents or a portion of the data associated with the one or more static objects.
